(19) United States
(12) Patent Application Publication
(10) Pub. No.: US 2026/0128485 A1
(43) Pub. Date: May 7, 2026

(54) BATTERY AND BATTERY MANUFACTURING METHOD

(71) Applicant: Panasonic Intellectual Property Management Co., Ltd., Osaka (JP)

(72) Inventors: Tatsuya OSHIMA, Osaka (JP); Tsutomu KOSHIZUKA, Osaka (JP); Kazuhiro MORIOKA, Osaka (JP)

(21) Appl. No.: 19/426,919

(22) Filed: Dec. 19, 2025

Related U.S. Application Data
(63) Continuation of application No. PCT/JP2024/018302, filed on May 17, 2024.

(30) Foreign Application Priority Data
Jun. 28, 2023 (JP) 2023-106322

(51) Int. Cl. H01M 50/586; H01M 10/0562; H01M 10/0585; H01M 10/42; H01M 50/406

(52) U.S. Cl. CPC H01M 50/586; H01M 10/0562; H01M 10/0585; H01M 10/4235; H01M 50/406

(57) ABSTRACT

A battery includes a unit cell including an electrode current collector, a first layer, a second layer, a third layer, and a counter electrode current collector. The first layer includes an electrode active material layer and a first insulating layer having an electronic insulation property. The second layer includes a solid electrolyte layer. The third layer includes a counter electrode active material layer. A first region not covered with the first layer is provided at an end portion of the main surface of the electrode current collector in the first direction. A second region not covered with the second layer in a plan view is provided at the end portion of the first layer in the first direction. A third region not covered with the third layer in the plan view is provided at an end portion of the second layer in the first direction.

### CROSS REFERENCE TO RELATED APPLICATIONS

This is a continuation application of PCT International Application No. PCT/JP2024/018302 filed on May 17, 2024, designating the United States of America, which is based on and claims priority of Japanese Patent Application No. 2023-106322 filed on Jun. 28, 2023. The entire disclosures of the above-identified applications, including the specifications, drawings and claims are incorporated herein by reference in their entirety.

### FIELD

The present disclosure relates to batteries and battery manufacturing methods.

### BACKGROUND

Patent Literature (PTL) 1 describes a battery in which an electrode current collector, an electrode active material layer, a solid electrolyte layer, a counter electrode active material layer, and a counter electrode current collector are stacked.

PTL 2 describes a battery in which an electrode current collector, an electrode active material layer, a solid electrolyte layer, a counter electrode active material layer, and a counter electrode current collector are stacked. In addition, in the battery described in PTL 2, non-opposed sites are provided at the ends of the electrode active material layer and the solid electrolyte layer.

PTL 3 describes a battery in which an electrode current collector, an electrode active material layer, a solid electrolyte layer, a counter electrode active material layer, and a counter electrode current collector are stacked. In addition, in the battery described in PTL 3, steps are provided in the electrode active material layer and the counter electrode active material layer, and an insulating layer is disposed on the counter electrode current collector.

### CITATION LIST

### Patent Literature

PTL 1: Japanese Unexamined Patent Application Publication No. 2019-140079
PTL 2: Japanese Unexamined Patent Application Publication No. 2020-129519
PTL 3: Japanese Unexamined Patent Application Publication No. 2022-104137

### SUMMARY

### Technical Problem

In view of the above, the present disclosure provides a battery suitable for achieving both high resistance to short circuits and high efficiency productivity.

### Solution to Problem

The battery according to one aspect of the present disclosure includes a unit cell including: an electrode current collector; a first layer disposed on a main surface of the electrode current collector; a second layer disposed on a side of the first layer opposite from the electrode current collector; a third layer disposed on a side of the second layer opposite from the first layer; and a counter electrode current collector disposed on a side of the third layer opposite from the second layer, wherein the first layer includes an electrode active material layer and a first insulating layer having an electronic insulation property, the first insulating layer being aligned with the electrode active material layer in a first direction that is a direction from a center of the main surface towards an outer edge of the main surface of the electrode current collector, the first insulating layer being disposed at an end portion of the first layer in the first direction, the second layer includes an electrolyte layer, the third layer includes a counter electrode active material layer, a first region not covered with the first layer is provided at an end portion of the main surface of the electrode current collector in the first direction, a second region not covered with the second layer in a plan view of the main surface of the electrode current collector is provided at the end portion of the first layer in the first direction, and a third region not covered with the third layer in the plan view is provided at an end portion of the second layer in the first direction.

A battery manufacturing method includes: preparing an electrode current collector and stacking a first layer on a main surface of the electrode current collector to provide a first region not covered with the first layer at an end portion of the main surface of the electrode current collector in a first direction that is a direction from a center of the main surface towards an outer edge of the main surface of the electrode current collector; stacking a second layer on a side of the first layer opposite from the electrode current collector to provide a second region not covered with the second layer in a plan view of the main surface of the electrode current collector at an end portion of the first layer in the first direction; stacking a third layer on a side of the second layer opposite from the first layer to provide a third region not covered with the third layer in the plan view at an end portion of the second layer in the first direction; and stacking a counter electrode current collector on a side of the third layer opposite from the second layer, wherein the first layer includes an electrode active material layer and a first insulating layer having an electronic insulation property, the first insulating layer being aligned with the electrode active material layer in the first direction, the first insulating layer being disposed at an end portion of the first layer in the first direction, the second layer includes an electrolyte layer, and the third layer includes a counter electrode active material layer.

### Advantageous Effects

According to the present disclosure, it is possible to provide a battery suitable for achieving both high resistance to short circuits and high efficiency productivity.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a top view of a battery according to Embodiment 1.

FIG. 2 is a cross-sectional view of a battery according to Embodiment 1.

FIG. 3 is a cross-sectional view illustrating another example of the structure of the end portion of the unit cell according to Embodiment 1.

FIG. 4 is a cross-sectional view of another battery according to Embodiment 1.

FIG. 5 is a top view of a battery according to Variation 1 of Embodiment 1.

FIG. 6 is a cross-sectional view of a battery according to Variation 1 of Embodiment 1.

FIG. 7 is a cross-sectional view of a battery according to Variation 2 of Embodiment 1.

FIG. 8 is a cross-sectional view of a battery according to Variation 3 of Embodiment 1.

FIG. 9 is a cross-sectional view of another battery according to Variation 3 of Embodiment 1.

FIG. 10 is a cross-sectional view of a battery according to Variation 4 of Embodiment 1.

FIG. 11 is a cross-sectional view of a battery according to Variation 5 of Embodiment 1.

FIG. 12 is a cross-sectional view of another battery according to Variation 5 of Embodiment 1.

FIG. 13 is a cross-sectional view of a battery according to Variation 6 of Embodiment 1.

FIG. 14 is a flow chart illustrating a method for manufacturing a battery according to Variation 5 of Embodiment 1.

FIG. 15 is a top view illustrating an example of a stacked electrode plate.

FIG. 16 is a cross-sectional view of a battery according to Embodiment 2.

FIG. 17 is a flow chart illustrating a method for manufacturing a battery according to Embodiment 2.

### DESCRIPTION OF EMBODIMENTS

### (Underlying Knowledge Forming Basis of the Present Disclosure)

As mentioned above, a battery has been proposed that includes a structure in which an electrode current collector, an electrode active material layer, a solid electrolyte layer, a counter electrode active material layer, and a counter electrode current collector are stacked. Generally, the electrode current collector and the electrode active material layer have electron conductivity with the counter electrode current collector and the counter electrode active material layer, and therefore, when these oppositely polarized electrodes come into contact, they become conductive, that is, short-circuited. For that reason, it is important for long-term use of batteries to have high resistance to short circuits. In addition, an electrical connection structure such as terminals may be formed at the end portion of the battery. Although an electrical connection structure can be easily formed by providing a region not covered with the electrode active material layer at the end portion of the electrode current collector, in this region, short circuits are likely to occur due to contact between (i) the electrode current collector and (ii) the counter electrode active material layer and the counter electrode current collector.

PTL 1 mentions stability in the event of a short circuit, but does not mention resistance to short circuits.

PTL 2 suggests that by providing a non-opposite portion on the electrode active material layer, resistance to short circuits is improved. However, the entire electrode current collector is covered with a layer, and it is expected that it will be difficult to form terminals for the purpose of conduction between batteries, for example.

PTL 3 suggests that providing non-opposite portions on a stacked body where the electrode active material layer and solid electrolyte layer are stacked with aligned outer edges, and providing an insulating layer on the counter electrode current collector, improves resistance to short circuits. However, in order to stack the outer edges of the electrode active material layer and the solid electrolyte layer in aligned positions, a stacking technology with high positional accuracy is required, and it is expected to be difficult to achieve highly efficient production due to factors such as longer tact time.

The inventors have studied a battery having a structure in which an electrode current collector, an electrode active material layer, a solid electrolyte layer, a counter electrode active material layer, and a counter electrode current collector are stacked. As a result, it has been found that in order to efficiently stack each layer while improving resistance to short circuits, it is effective to provide a region not covered with layers adjacent to that layer at least in part. Furthermore, it has been found that in order to improve resistance to short circuits, it is effective to provide an insulating layer at least at the end portions of some of the layers. With the above-mentioned view, the structure according to the present disclosure has been conceived.

### Overview of the Present Disclosure

The following is an overview of the present disclosure and shows examples of a battery and a battery manufacturing method according to the present disclosure.

The battery according to the first aspect of the present disclosure includes a unit cell including: an electrode current collector; a first layer disposed on a main surface of the electrode current collector; a second layer disposed on a side of the first layer opposite from the electrode current collector; a third layer disposed on a side of the second layer opposite from the first layer; and a counter electrode current collector disposed on a side of the third layer opposite from the second layer, wherein the first layer includes an electrode active material layer and a first insulating layer having an electronic insulation property, the first insulating layer being aligned with the electrode active material layer in a first direction that is a direction from a center of the main surface towards an outer edge of the main surface of the electrode current collector, the first insulating layer being disposed at an end portion of the first layer in the first direction, the second layer includes an electrolyte layer, the third layer includes a counter electrode active material layer, a first region not covered with the first layer is provided at an end portion of the main surface of the electrode current collector in the first direction, a second region not covered with the second layer in a plan view of the main surface of the electrode current collector is provided at the end portion of the first layer in the first direction, and a third region not covered with the third layer in the plan view is provided at an end portion of the second layer in the first direction.

Accordingly, at the end portion of a unit cell in a first direction where a first region is provided to easily form an electrical connection structure with an electrode current collector, a first insulating layer is disposed at the end portion of the first layer, which can suppress contact between electrodes of opposite polarity within the electrode active material layer and improve the resistance of a battery to short circuits. Furthermore, since the second region and the third region are provided at the end portion of the unit cell in the first direction, the end portion of the second layer is supported by the first layer, and the end portion of the third layer is supported by the second layer. As a result, collapse of the second layer and the third layer can be suppressed at the end portion in the first direction of the unit cell, which makes it easy to form terminals. In addition, since the second region and the third region are provided, even if the positional accuracy when the second layer and the third layer are formed is not high, at the end portion of the unit cell in the first direction, it is possible to avoid a structure where the outer edge of the second layer and the outer edge of the third layer protrude beyond the first layer and the second layer, respectively, making them prone to collapse, thereby facilitating improved productivity. As a result of the above, according to the present aspect, it is possible to realize a battery suitable for achieving both high resistance to short circuits and high efficiency productivity.

In addition, for example, the battery according to the second aspect of the present disclosure is the battery according to the first aspect, wherein the unit cell may include two first layers, two second layers, two third layers, and two counter electrode current collectors, the two first layers each being the first layer, the two second layers each being the second layer, the two third layers each being the third layer, the two counter electrode current collectors each being the counter electrode current collector, the two first layers may be disposed on two main surfaces of the electrode current collector, the two main surfaces including the main surface, the two second layers may be disposed on sides of the two first layers opposite from the electrode current collector, the two third layers may be disposed on sides of the two second layers opposite from the two first layers, the two counter electrode current collectors may be disposed on sides of the two third layers opposite from the two second layers, the first region may be provided at an end portion of each of the two main surfaces of the electrode current collector in the first direction, the second region may be provided at an end portion of each of the two first layers in the first direction, and the third region may be provided at an end portion of each of the two second layers in the first direction.

This allows for a structure that is highly resistant to the short circuits and can be manufactured with high efficiency on both main surfaces of the electrode collector. In addition, when the unit cells are densified by pressing or the like, there is less likely to be a difference in the stress applied to both sides of the electrode current collector in the stacking direction, and warping of the unit cells can be suppressed.

In addition, for example, the battery according to the third aspect of the present disclosure is the battery according to the first aspect, wherein a fourth region not covered with the counter electrode current collector in the plan view may be provided at an end portion of the third layer in the first direction.

This suppresses contact between the counter electrode current collector and the outer edge of the third layer in the first direction during stacking of the counter electrode current collector, thereby suppressing collapse at the end portion of the third layer. In addition, the distance between the counter electrode current collector and the electrode current collector becomes longer, and contact between the counter electrode current collector and the electrode current collector can be suppressed.

In addition, for example, the battery according to the fourth aspect of the present disclosure is the battery according to the third aspect, wherein the unit cell may include two first layers, two second layers, two third layers, and two counter electrode current collectors, the two first layers each being the first layer, the two second layers each being the second layer, the two third layers each being the third layer, the two counter electrode current collectors each being the counter electrode current collector, the two first layers may be disposed on two main surfaces of the electrode current collector, the two main surfaces including the main surface, the two second layers may be disposed on sides of the two first layers opposite from the electrode current collector, the two third layers may be disposed on sides of the two second layers opposite from the two first layers, the two counter electrode current collectors may be disposed on sides of the two third layers opposite from the two second layers, the first region may be provided at an end portion of each of the two main surfaces of the electrode current collector in the first direction, the second region may be provided at an end portion of each of the two first layers in the first direction, the third region may be provided at an end portion of each of the two second layers in the first direction, and the fourth region may be provided at an end portion of each of the two third layers in the first direction.

This enables the realization of a structure with high resistance to short circuits and high production efficiency on both main surface sides of the electrode current collector. In addition, when the unit cells are densified by pressing or the like, there is less likely to be a difference in the stress applied to both sides of the electrode current collector in the stacking direction, and warping of the unit cells can be suppressed.

In addition, for example, the battery according to the fifth aspect of the present disclosure is the battery according to any one of the first aspect to the fourth aspect, wherein the second layer may further include a second insulating layer having an electronic insulation property, the second insulating layer being aligned with the electrolyte layer in the first direction and disposed at an end portion of the second layer in the first direction.

This allows the second insulating layer to suppress collapse of the electrolyte layer.

In addition, for example, the battery according to the sixth aspect of the present disclosure is a battery according to any one of the first aspect to the fourth aspect, wherein the third region may be part of the electrolyte layer.

Accordingly, electronic insulation properties can be ensured at the end portion of the second layer, and it is not necessary to form another insulating layer to ensure such electronic insulation properties, so that the second layer can be formed collectively, allowing the battery to be manufactured at low cost and at high efficiency.

In addition, for example, the battery according to the seventh aspect of the present disclosure is the battery according to any one of the first aspect to sixth aspects, wherein the third layer may further include a third insulating layer having an electronic insulation property, the third insulating layer being aligned with the counter electrode active material layer in the first direction, the third insulating layer being disposed at an end portion of the third layer in the first direction.

This allows the third insulating layer to suppress contact of the different polarity electrodes with the counter electrode active material layer, and the resistance to short circuits of the battery can be improved. In addition, collapse of the counter electrode active material layer can be suppressed.

In addition, for example, the battery according to the eighth aspect of the present disclosure is the battery according to any one of the first aspect to the seventh aspect, wherein side surfaces of the electrode current collector, the first layer, the second layer, and the third layer may be flush with each other at an end portion of the unit cell in a second direction that is a direction from the center towards the outer edge of the main surface of the electrode current collector, the second direction being different from the first direction.

This allows a first region or the like to be provided at the end of the unit cell in the first direction, while at the end of the unit cell in the second direction different from the first direction, there are no steps on the side surfaces of the first layer, the second layer, and the third layer stacked on the electrode current collector, and spaces that do not function as batteries due to the steps are not formed, resulting in a substantial improvement in the volume energy density of the battery.

In addition, for example, the battery according to the ninth aspect of the present disclosure is the battery according to any one of the first aspect to the seventh aspect, wherein side surfaces of the electrode current collector, the first layer, the second layer, the third layer, and the counter electrode current collector may be flush with each other at an end portion of the unit cell in a second direction that is a direction from the center towards the outer edge of the main surface of the electrode current collector, the second direction being different from the first direction.

This allows a first region or the like to be provided at the end portion of the unit cell in the first direction, while at the end portion of the unit cell in the second direction different from the first direction, there are no steps on the side surfaces of each layer, and spaces that do not function as batteries due to the steps are not formed, resulting in a substantial improvement in the volume energy density of the battery.

In addition, for example, the battery according to the tenth aspect of the present disclosure is the battery according to any one of the first aspect to the ninth aspect, wherein at least one layer selected from a group consisting of the electrode active material layer, the first insulating layer, and the electrolyte layer may include a sulfide solid electrolyte.

Accordingly, at least one of the electrode active material layer, the first insulating layer and the electrolyte layer includes a sulfide solid electrolyte with excellent ionic conductivity, moldability, and insulation properties, making it possible to achieve high output of the battery in addition to achieving high resistance to short circuits of the battery and high efficiency productivity.

In addition, for example, the battery according to the eleventh aspect of the present disclosure is the battery according to any one of the first aspect to the tenth aspect, wherein at least one layer selected from a group consisting of the electrode active material layer, the first insulating layer, and the electrolyte layer may include a styrene-based elastomer.

Accordingly, at least one of the electrode active material layer, the first insulating layer, or the electrolyte layer contains a styrene-based elastomer with excellent flexibility and elasticity, making it difficult for the layer containing the styrene-based elastomer to collapse, and the high resistance to short circuits of the battery can be further improved.

In addition, for example, the battery according to the twelfth aspect of the present disclosure is the battery according to any one of the first aspect to the eleventh aspect, wherein part of the end portion of the counter electrode current collector in the first direction may protrude in the first direction relative to the third layer in the plan view.

This makes it possible to form an electrical connection structure such as terminals on the counter electrode current collector at the end portion of the battery in the first direction, making the structure less complicated than when an electrical connection structure is formed on the main surface of the counter electrode current collector.

In addition, for example, the battery according to the thirteenth aspect of the present disclosure is the battery according to any one of the first aspect to the twelfth aspect, the battery including a plurality of unit cells, each of the plurality of unit cells being the unit cell, wherein the plurality of unit cells may be stacked.

Accordingly, since the unit cells described above are stacked, a stacked battery suitable for achieving both high resistance to short circuits and high efficiency productivity can be realized.

In addition, the battery manufacturing method according to the fourteenth aspect of the present disclosure includes: preparing an electrode current collector and stacking a first layer on a main surface of the electrode current collector to provide a first region not covered with the first layer at an end portion of the main surface of the electrode current collector in a first direction that is a direction from a center of the main surface towards an outer edge of the main surface of the electrode current collector; stacking a second layer on a side of the first layer opposite from the electrode current collector at an end portion of the first layer in the first direction to provide a second region not covered with the second layer in a plan view of the main surface of the electrode current collector; stacking a third layer on a side of the second layer opposite from the first layer to provide a third region not covered with the third layer in the plan view at an end portion of the second layer in the first direction; and stacking a counter electrode current collector on a side of the third layer opposite from the second layer, wherein the first layer includes an electrode active material layer and a first insulating layer having an electronic insulation property, the first insulating layer being aligned with the electrode active material layer in the first direction, the first insulating layer being disposed at an end portion of the first layer in the first direction, the second layer includes an electrolyte layer, and the third layer includes a counter electrode active material layer. preparing an electrode current collector and stacking a first layer on a main surface of the electrode current collector to provide a first region not covered with the first layer at an end portion of the main surface of the electrode current collector in a first direction that is a direction from a center of the main surface towards an outer edge of the main surface of the electrode current collector; stacking a second layer on a side of the first layer opposite from the electrode current collector to provide a second region not covered with the second layer in a plan view of the main surface of the electrode current collector at an end portion of the first layer in the first direction; stacking a third layer on a side of the second layer opposite from the first layer to provide a third region not covered with the third layer in the plan view at an end portion of the second layer in the first direction; and stacking a counter electrode current collector on a side of the third layer opposite from the second layer, wherein the first layer includes an electrode active material layer and a first insulating layer having an electronic insulation property, the first insulating layer being aligned with the electrode active material layer in the first direction, the first insulating layer being disposed at an end portion of the first layer in the first direction, the second layer includes an electrolyte layer, and the third layer includes a counter electrode active material layer.

In addition, for example, the battery manufacturing method according to the fifteenth aspect of the present disclosure is the battery manufacturing method according to the fourteenth aspect, wherein in the stacking of the counter electrode current collector, the counter electrode current collector may be stacked on the third layer to provide a fourth region not covered with the counter electrode current collector in the plan view at an end portion of the third layer in the first direction.

Accordingly, it is possible to manufacture batteries that are suitable for achieving both high resistance to short circuits of the batteries described above and high efficiency productivity.

In addition, for example, the battery manufacturing method according to the sixteenth aspect of the present disclosure is the battery manufacturing method according to the fourteenth aspect or the fifteenth aspect, and may further include forming a cut surface at an end portion of a stacked body in a second direction by collectively cutting the electrode current collector, the first layer, the second layer, and the third layer in a direction intersecting the main surface of the electrode current collector, the second direction being different from the first direction and being a direction from the center towards the outer edge of the main surface of the electrode current collector, the electrode current collector, the first layer, the second layer, and the third layer being stacked in the stacked body.

This allows for easy manufacturing of batteries, since there is no need to stack the electrode current collector, the first layer, the second layer, and the third layer in the shape after cutting. In addition, since the capacity of the battery can be adjusted at the position where the stacked body is to be cut, the capacity accuracy can be increased.

In addition, for example, the battery manufacturing method according to the seventeenth aspect of the present disclosure is the battery manufacturing method according to the fourteenth aspect or the fifteenth aspect, and may further include forming a cut surface at an end portion of a stacked body in a second direction by collectively cutting the electrode current collector, the first layer, the second layer, the third layer, and the counter electrode current collector in a direction intersecting the main surface of the electrode current collector, the second direction being different from the first direction and being a direction from the center towards the outer edge of the main surface of the electrode current collector, the second direction, the electrode current collector, the first layer, the second layer, the third layer, and the counter electrode current collector being stacked in the stacked body.

This allows for easy manufacturing of batteries, since there is no need to stack the electrode current collector, the first layer, the second layer, the third layer, and the counter electrode current collector in the shape after cutting. In addition, since the capacity of the battery can be adjusted at the position where the stacked body is to be cut, the capacity accuracy can be increased.

In the following, the embodiments of the present disclosure will be described with reference to the drawings.

It should be noted that all of the embodiments described below shows comprehensive or specific examples. The numerical values, shapes, materials, components, arrangement and connections of the components, steps, order of steps, and the like shown in the following embodiments are merely examples and are not intended to limit the present disclosure. In addition, among the components in the following embodiments, components not described in the independent claims are described as arbitrary components.

In addition, each figure is a schematic view and is not necessarily exactly illustrated. Therefore, for example, scales and the like in each figure do not necessarily match. In addition, in each figure, the same reference numerals are assigned to substantially the same configurations, and duplicate descriptions will be omitted or simplified.

In addition, in the present specification, terms that indicate the relationship between elements such as parallel or orthogonal, and terms that indicate the shape of elements such as rectangular or circular, as well as numerical ranges are not expressions that represent exact meanings, but are expressions that mean substantially equivalent ranges, including differences of approximately a few percent.

In addition, in the present specification and drawings, the x-axis, y-axis and z-axis represent the three axes of a three-dimensional Cartesian coordinate system. The x-axis and y-axis are directions parallel to the main surface of the electrode current collector, and the z-axis is a direction perpendicular to the main surface of the electrode current collector. When the battery has a rectangular shape in a plan view, the x-axis and y-axis are respectively in a direction parallel to the first side of the rectangle and in a direction parallel to the second side perpendicular to the first side. The z-axis is the stacking direction of a plurality of unit cells included in the battery. In addition, in the present specification, the “stacking direction” coincides with the direction normal to the main surface of the current collector and the active material layer. In addition, in the present specification, “plan view” refers to viewing from a direction perpendicular to the main surface of the electrode current collector unless otherwise stated.

In addition, unless otherwise stated in the present specification, “protruding” means protruding outward relative to the center of the unit cell in a cross-section view perpendicular to the main surface of the electrode current collector. “Element A protrudes relative to element B” means that in the protruding direction, the tip of element A protrudes more than the tip of element B, that is, the tip of element A is farther from the center of the unit cell than the tip of element B. The “protruding direction” is considered to be a direction parallel to the main surface of the electrode current collector. In addition, “protrusion of element A” means a portion of element A that protrudes relative to the tip of element B in the protruding direction. In addition, element B may be a portion other than the protrusion of element A. The elements include, for example, an active material layer, a solid electrolyte layer, an insulating layer, a current collector, and the like.

In addition, in the present specification, unless otherwise stated, ordinals such as “first” and “second” do not mean the number or order of components, and are used for the purpose of avoiding confusion and distinguishing between similar components.

### Embodiment 1

### [1. Configuration]

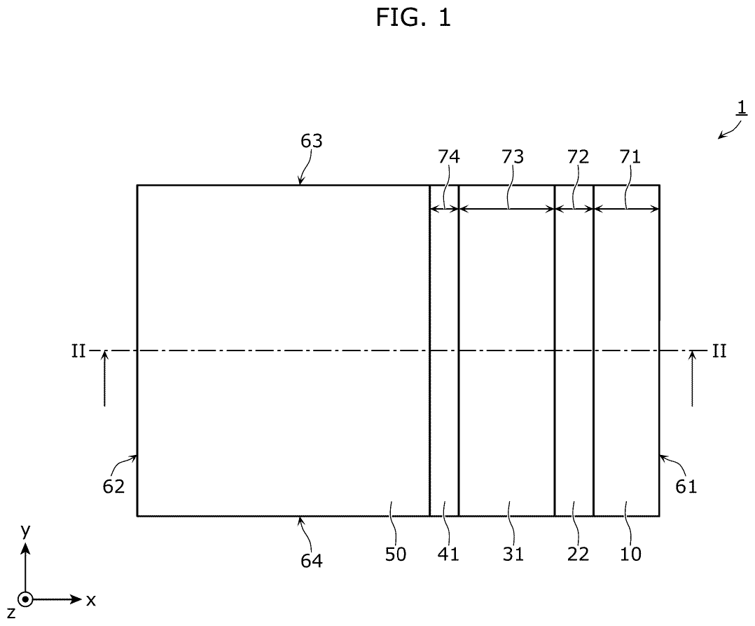

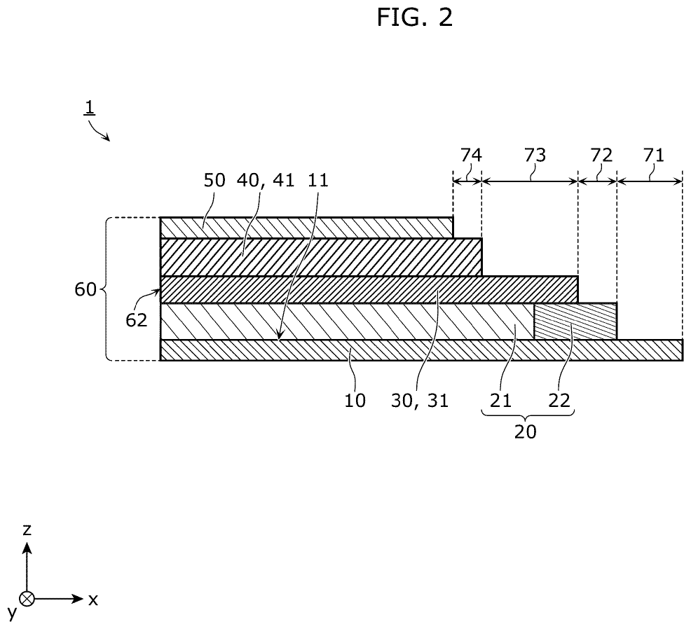

First, the configuration of the battery according to Embodiment 1 will be described with reference to FIG. 1 and FIG. 2.

FIG. 1 is a top view of battery 1 according to the present embodiment. FIG. 2 is a cross-sectional view of battery 1 according to the present embodiment. FIG. 1 illustrates the shape of battery 1 when viewed from the positive side of the z-axis. In addition, FIG. 2 is a cross-sectional view taken at the position shown along line II-II in FIG. 1.

As illustrated in FIG. 1 and FIG. 2, battery 1 according to the present embodiment includes unit cell 60 including electrode current collector 10, first layer 20 including electrode active material layer 21 and first insulating layer 22, second layer 30 including solid electrolyte layer 31, third layer 40, and counter electrode current collector 50. In unit cell 60, electrode current collector 10, first layer 20, second layer 30, third layer 40 including counter electrode active material layer 41, and counter electrode current collector 50 are stacked in this order along the z-axis. As illustrated in FIG. 2, battery 1 is formed from a single unit cell 60. Battery 1 is, for example, an all-solid-state battery.

As illustrated in FIG. 1 and FIG. 2, unit cell 60 includes side surfaces 61 and 62 that face away from each other, and side surfaces 63 and 64 that face away from each other. Side surface 61 is the side surface of unit cell 60 in the direction in which the x-axis extends towards the positive side. Side surface 62 is the side surface of unit cell 60 in the direction in which the x-axis extends towards the negative side. Side surface 63 is the side surface of unit cell 60 in the direction in which the y-axis extends towards the positive side. Side surface 64 is the side surface of unit cell 60 in the direction in which the y-axis extends towards the negative side.

In the following, the direction in which the x-axis extends towards the positive side will be referred to as the “x-axis positive side direction”. In addition, in the following, the direction in which the x-axis extends towards the negative side will be referred to as the “x-axis negative side direction”. In addition, in the following, the direction in which the y-axis extends towards the positive side will be referred to as the “y-axis positive side direction”. In addition, in the following, the direction in which the y-axis extends towards the negative side will be referred to as the “y-axis negative side direction”. The x-axis positive side and x-axis negative side directions and the y-axis positive side and y-axis negative side directions are perpendicular to each other. In addition, the x-axis positive side direction and the x-axis negative side direction are opposite to each other, and the y-axis positive side direction and the y-axis negative side direction are opposite to each other. In this specification, the x-axis positive side direction is an example of a first direction that is a direction from the center towards the outer edge of main surface 11 of electrode current collector 10. In addition, the x-axis negative side direction is an example of a second direction that is a direction from the center towards the outer edge of main surface 11 of electrode current collector 10, and is different from the first direction. It should be noted that the y-axis positive side direction or the y-axis negative side direction may be the second direction.

In FIG. 1, first region 71, second region 72, third region 73, and fourth region 74 are provided at the end portion of unit cell 60 on the side surface 61 side, but these regions may be provided at the end portion of unit cell 60 on the side surface 62 side, the side surface 63 side, or the side surface 64 side. First region 71, second region 72, third region 73 and fourth region 74 will be described in detail later.

The shapes of battery 1 and unit cell 60 in a plan view are rectangular as illustrated in FIG. 1. That is, the shapes of battery 1 and unit cell 60 are generally flattened rectangular parallelepiped. Here, flattened means that the thickness is shorter than each side or the maximum width of the main surface. Each side or the maximum width of the main surface of battery 1 and unit cell 60 is, for example, at least 10 mm and at most 500 mm. The shapes of battery 1 and unit cell 60 in a plan view may be polygonal such as square, hexagonal or octagonal, or may be circular or elliptical. It should be noted that in the drawings according to this specification, the thickness of each layer is exaggerated in the illustration in order to make it easier to understand the layer structure of the unit cell. In addition, in the drawings according to this specification, the lengths of first region 71, second region 72, third region 73 and fourth region 74 in the x-axis positive side direction are exaggerated in the illustration in order to make it easier to understand the structure of the unit cell in first region 71, second region 72, third region 73 and fourth region 74.

Side surfaces 62, 63 and 64 of unit cell 60 are formed of the side surfaces of electrode current collector 10, first layer 20, second layer 30, third layer 40, and counter electrode current collector 50, and at least part thereof may be a flat plane. When at least part of side surface 62, 63 or 64 is a flat plane, at least the side surfaces of electrode current collector 10, first layer 20, second layer 30 and third layer 40 in these flat planes are positioned on the same flat plane in a state where there are no steps from each other. That is, at the end portions of unit cell 60 in the x-axis negative side direction, y-axis positive side direction, and y-axis negative side direction, the side surfaces of electrode current collector 10, first layer 20, second layer 30 and third layer 40 are flush with each other. Furthermore, at the end portions of unit cell 60 in the x-axis negative side direction, y-axis positive side direction, and y-axis negative side direction, the side surfaces of electrode current collector 10, first layer 20, second layer 30, third layer 40, and counter electrode current collector 50 may be flush with each other. Accordingly, at the end portions of unit cell 60 where first region 71, second region 72, third region 73, and fourth region 74 are not provided, there are no steps on the side surfaces of the respective layers, and spaces that do not function as a battery due to the steps are not formed, resulting in a substantial improvement in the volume energy density of battery 1. In addition, the side surfaces of the respective layers can be made flush by cutting the layers together, and the like, making it easier to manufacture battery 1.

In addition, at the end portions in the x-axis negative side direction, y-axis positive side direction, and y-axis negative side direction, the side surface of first layer 20 includes the side surface of electrode active material layer 21, the side surface of second layer 30 includes the side surface of solid electrolyte layer 31, and the side surface of third layer 40 includes the side surface of counter electrode active material layer 41. For that reason, at the end portions in the x-axis negative side direction, y-axis positive side direction, and y-axis negative side direction, the side surfaces of electrode current collector 10, electrode active material layer 21, solid electrolyte layer 31, counter electrode active material layer 41, and counter electrode current collector 50 are flush with each other.

Side surfaces 62, 63 and 64 are, for example, cut surfaces. Specifically, side surfaces 62, 63 and 64 are surfaces formed by cutting with a blade or the like of a cutter or the like, and are surfaces including, for example, cutting marks such as fine grooves. Because they are cut surfaces, the side surfaces of the respective layers of unit cell 60 can be easily made flush. It should be noted that the cutting marks may be smoothed by polishing or the like. The shape of the cut surface is not limited.

As illustrated in FIG. 1, when the shape of unit cell 60 is rectangular in a plan view, each of side surfaces 61, 62, 63, and 64 forms one side of the rectangular in unit cell 60 in a plan view.

Unit cell 60 includes one electrode current collector 10, one first layer 20, one second layer 30, one third layer 40, and one counter electrode current collector 50. In a plan view, electrode current collector 10, electrode active material layer 21, solid electrolyte layer 31, counter electrode active material layer 41, and counter electrode current collector 50 overlap.

Electrode current collector 10 is in contact with electrode active material layer 21 and first insulating layer 22 of first layer 20 on one main surface 11. The thickness of electrode current collector 10 is, for example, at least 5 μm and at most 100 μm. It should be noted that in this specification, the thickness of the current collector and each layer is the length in the stacking direction, and unless otherwise noted, it is the average value of the overall thickness.

Known materials can be used as the material for electrode current collector 10. For example, a foil-like body, a plate-like body, a mesh-like body, or the like made of copper, aluminum, nickel, iron, stainless steel, platinum, gold, two or more alloys thereof, or the like is used for electrode current collector 10. It should be noted that in addition to the foil-like body, plate-like body, mesh-like body, or the like, electrode current collector 10 may include a connection layer, which is a layer containing a conductive material, provided in a portion that contacts first layer 20.

Counter electrode current collector 50 is disposed on the side of third layer 40 opposite from second layer 30 side. Counter electrode current collector 50 is in contact with the upper surface of third layer 40. Counter electrode current collector 50 faces electrode current collector 10 through first layer 20, second layer 30 and third layer 40. The thickness of counter electrode current collector 50 is, for example, at least 5 μm and at most 100 μm.

Known materials can be used as the material for counter electrode current collector 50. For example, a foil-like body, a plate-like body, a mesh-like body, or the like made of copper, aluminum, nickel, iron, stainless steel, platinum, gold, two or more alloys thereof, or the like is used for counter electrode current collector 50. It should be noted that in addition to the foil-like body, plate-like body, mesh-like body, or the like, counter electrode current collector 50 may include a connection layer, which is a layer containing a conductive material, provided in a portion that contacts third layer 40.

First layer 20 includes electrode active material layer 21 and first insulating layer 22 that is aligned with electrode active material layer 21 in the x-axis positive side direction and is disposed at the end portion of first layer 20 in the x-axis positive side direction. First layer 20 is disposed on one main surface 11 of electrode current collector 10. The thickness of each of electrode active material layer 21 and first insulating layer 22 is, for example, at least 5 μm and at most 300 μm. The thickness of electrode active material layer 21 and the thickness of first insulating layer 22 are, for example, substantially the same. Substantially the same means, for example, that for any one of two comparison objects, the difference between the two comparison objects is less than or equal to 5%. The thickness of first insulating layer 22 may be smaller than the thickness of electrode active material layer 21.

Electrode active material layer 21 is disposed on one main surface 11 of electrode current collector 10. In addition, the surface of electrode active material layer 21 opposite from electrode current collector 10 side is in contact with solid electrolyte layer 31. The surface of electrode active material layer 21 opposite from electrode current collector 10 side is completely covered with solid electrolyte layer 31. Electrode active material layer 21 and counter electrode active material layer 41 face each other with solid electrolyte layer 31 interposed therebetween. In a plan view, the area of electrode active material layer 21 is larger than the area of counter electrode active material layer 41. The outer edge of electrode active material layer 21 in the x-axis positive side direction is located outside the outer edge of counter electrode active material layer 41 in the x-axis positive side direction. The material used for electrode active material layer 21 will be described later.

First insulating layer 22 has electronic insulation properties. First insulating layer 22 may further have ionic insulating properties. First insulating layer 22 is in contact with main surface 11 and the end surface of electrode active material layer 21 in the x-axis positive side direction. First insulating layer 22 can suppress contact with the opposite polarity electrode to electrode active material layer 21, thereby improving resistance of battery 1 to short circuits.

First insulating layer 22 extends on main surface 11 in the direction (y-axis direction) in which the end surface of electrode active material layer 21 extends in the x-axis positive side direction. First insulating layer 22 includes a portion that does not overlap with electrode active material layer 21 in a plan view. In addition, the surface of first insulating layer 22 opposite from electrode current collector 10 side is in contact with solid electrolyte layer 31. In addition, first insulating layer 22 is provided along the entire end portion of electrode active material layer 21 in the x-axis positive side direction, but may be provided at part of the end portion of electrode active material layer 21 in the x-axis positive side direction. The material used for first insulating layer 22 will be described later.

Second layer 30 entirely includes solid electrolyte layer 31. Second layer 30 is disposed on the side of first layer 20 opposite from electrode current collector 10 side. The thickness of solid electrolyte layer 31 is, for example, at least 5 μm and at most 150 μm.

Solid electrolyte layer 31 is disposed on the side of electrode active material layer 21 opposite from electrode current collector 10 side. Solid electrolyte layer 31 is located between electrode active material layer 21 and counter electrode active material layer 41, and is in contact with electrode active material layer 21 and counter electrode active material layer 41. Solid electrolyte layer 31 covers part of the surface of first insulating layer 22 opposite from electrode current collector 10 side. The material used for solid electrolyte layer 31 will be described later.

Third layer 40 entirely includes counter electrode active material layer 41. Third layer 40 is disposed on the side of second layer 30 opposite from the first layer 20 side. The thickness of counter electrode active material layer 41 is, for example, at least 5 μm and at most 300 μm.

Counter electrode active material layer 41 is disposed on the side of solid electrolyte layer 31 opposite from the electrode active material layer 21 side. Counter electrode active material layer 41 is stacked on solid electrolyte layer 31 and faces electrode active material layer 21. The material used for counter electrode active material layer 41 will be described later.

Here, the materials used for solid electrolyte layer 31, electrode active material layer 21, counter electrode active material layer 41, and first insulating layer 22 will be described.

Solid electrolyte layer 31 is an example of an electrolyte layer containing an electrolyte material. Solid electrolyte layer 31 includes at least a solid electrolyte as the electrolyte material, and may include a binder material if necessary. Solid electrolyte layer 31 may include a solid electrolyte having lithium ion conductivity. The electrolyte material contained in solid electrolyte layer 31 is, for example, entirely a solid electrolyte, excluding unavoidable impurities. It should be noted that the electrolyte material used for solid electrolyte layer 31 may further include a nonaqueous electrolyte, a gel electrolyte, or an ionic liquid, provided that the solid electrolyte is included as the main component. In the following, a description will be given of a case in which all of the electrolyte materials contained in solid electrolyte layer 31 are solid electrolytes.

Known materials such as lithium ion conductors, sodium ion conductors, or magnesium ion conductors can be used as the solid electrolyte. For example, solid electrolyte materials such as sulfide solid electrolytes, halide solid electrolytes, oxide solid electrolytes, polymer solid electrolytes, or complex hydride solid electrolytes are used as the solid electrolyte.

As sulfide solid electrolytes, materials capable of conducting lithium ions can be used, for example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, and the like. To these, LiX, Li₂O, MO_{q}, LiₚMO_{q}, and the like may be added. The element X in “LiX” is at least one element selected from the group consisting of F, Cl, Br, and I. The element M in “MO_{q}” and “LiₚMO_{q}” is at least one element selected from the group consisting of P, Si, Ge, B, Al, Ga, In, Fe, and Zn. The p and q in “MO_{q}” and “LiₚMO_{q}” are each independently a natural number.

As a sulfide solid electrolyte, for example, a Li₂S—P₂S₅-based glass ceramic may be used. To the Li₂S—P₂S₅-based glass ceramic, LiX, Li₂O, MO_{q}, LiₚMO_{q}, or the like may be added, and two or more selected from LiCl, LiBr, and LiI may also be added. Since Li₂S—P₂S₅-based glass ceramic is a relatively soft material, according to battery 1 containing Li₂S—P₂S₅-based glass ceramic, a battery with high durability can be manufactured.

As oxide solid electrolytes, for example, the following can be used: NASICON-type solid electrolytes represented by LiTi₂(PO₄)₃ and its element-substituted variants; (LaLi)TiO₃-based perovskite-type solid electrolytes; LISICON-type solid electrolytes represented by Li₁₄ZnGe₄O₁₆, Li₄SiO₄, LiGeO₄ and their element-substituted variants; garnet-type solid electrolytes represented by Li₇La₃Zr₂O₁₂ and its element-substituted variants; glasses and glass-ceramics based on Li—B—O compounds such as Li₃PO₄ and its N-substituted variants, LiBO₂, Li₃BO₃, with additions such as Li₂SO₄ and Li₂CO₃; and the like.

As halide solid electrolytes, for example, the following can be used: Li₃Y(Cl,Br,I)₆, Li_{2.7}Y_{1.1}(Cl,Br,I)₆, Li₂Mg(F,Cl,Br,I)₄, Li₂Fe(F,Cl,Br,I)₄, Li(Al,Ga,In)(F,Cl,Br,I)₄, Li₃(Al,Ga,In) (F,Cl,Br,I)₆, Li₃(Ca,Y,Gd)(Cl,Br,I)₆, Li_{2.7}(Ti,Al)F₆, Li_{2.5}(Ti,Al)F₆, Li(Ta,Nb)O(F,Cl)₄, and the like. It should be noted that in the present disclosure, when elements in a formula are represented as “(Al, Ga, In)”, this notation indicates at least one element selected from the group of elements within the parentheses. That is, “(Al, Ga, In)” is synonymous with “at least one element selected from the group consisting of Al, Ga, and In”. The same applies to other elements.

As a polymer solid electrolyte, for example, a compound of a polymer compound and a lithium salt can be used. The polymer compound may have an ethylene oxide structure. A polymer compound with an ethylene oxide structure can contain a large amount of lithium salt. For that reason, it is possible to further improve ionic conductivity. As the lithium salt, LiPF₆, LiBF₄, LiSbF₆, LiASF₆, LiSO₃CF₃, LiN(SO₂F)₂, LiN(SO₂CF₃)₂, LiN(SO₂C₂F₅)₂, LiN(SO₂CF₃)(SO₂C₄F₉), LiC(SO₂CF₃)₃, and the like can be used. A single lithium salt may be used alone, or two or more may be used in combination.

As the solid electrolyte complex hydride, for example, LiBH₄—LiI, LIBH₄—P₂S₅, and the like can be used.

As the binder material, for example, elastomers such as styrene-based elastomers is used, and organic compounds such as polyvinylidene fluoride, polytetrafluoroethylene, acrylic resins, or cellulose resins may be used.

Styrene-based elastomers refer to elastomers containing repeating units derived from styrene. Repeating units refer to molecular structures derived from monomers and are sometimes referred to as structural units. Styrene-based elastomers are suitable as binder materials because of their excellent flexibility and elasticity. The content of repeating units derived from styrene in the styrene-based elastomer is not particularly limited, and is, for example, at least 5% by mass and at most 70% by mass.

The styrene-based elastomer may be a block copolymer that includes a first block composed of repeating units derived from styrene and a second block composed of repeating units derived from conjugated diene. Examples of conjugated dienes include butadiene and isoprene. Repeated units derived from conjugated dienes may be hydrogenated. That is, the repeating unit derived from the conjugated diene may or may not have an unsaturated bond such as a carbon-carbon double bond. The block copolymer may have an arrangement of triblocks made up of two first blocks and one second block. The block copolymer may be an ABA type triblock copolymer. In this triblock copolymer, block A corresponds to the first block and block B corresponds to the second block. The first block, for example, functions as a hard segment. The second block, for example, functions as a soft segment.

Examples of styrene-based elastomers include styrene-ethylene/butylene-styrene block copolymer (SEBS), styrene-ethylene/propylene-styrene block copolymer (SEPS), styrene-ethylene/ethylene/propylene-styrene block copolymer (SEEPS), styrene-butadiene rubber (SBR), styrene-butadiene-styrene block copolymer (SBS), styrene-isoprene-styrene block copolymer (SIS), and hydrogenated styrene-butadiene rubber (HSBR). The styrene-based elastomer may contain SBR or SEBS. As the binder material, a mixture containing two or more selected from these may be used. Because styrene-based elastomers have excellent flexibility and elasticity, they are suitable as binder materials.

The styrene-based elastomer may be a styrene-based triblock copolymer. Examples of the styrene-based triblock copolymer include styrene-ethylene/butylene-styrene block copolymer (SEBS), styrene-ethylene/propylene-styrene block copolymer (SEPS), styrene-ethylene/ethylene/propylene-styrene block copolymer (SEEPS), styrene-butadiene-styrene block copolymer (SBS), and styrene-isoprene-styrene block copolymer (SIS). These styrene-based triblock copolymers are sometimes referred to as styrene-based thermoplastic elastomers. These styrene-based triblock copolymers tend to be flexible and have high strength.

Styrene-based elastomers may contain modified groups. A modified group means all repeating units contained in a polymer chain, some repeating units contained in a polymer chain, or functional groups that chemically modify terminal portions of the polymer chain.

The binder material may include binder materials other than styrene-based elastomers. Alternatively, the binder material may be a styrene-based elastomer. In other words, the binder material may contain only styrene-based elastomers.

In the present embodiment, one of electrode active material layer 21 or counter electrode active material layer 41 is a positive electrode active material layer, and the other is a negative electrode active material layer.

The positive electrode active material layer may contain at least a positive electrode active material, and may include at least one of an electrolyte material such as a solid electrolyte, a conductive aid, or a binder material, if necessary.

As the positive electrode active material, known materials capable of absorbing and releasing (intercalating and deintercalating, or dissolving and precipitating) lithium ions, sodium ions, magnesium ions, or the like can be used. As the positive electrode active material, materials capable of deintercalating and intercalating lithium ions, such as transition metal oxides, transition metal fluorides, polyanion materials, fluorinated polyanion materials, transition metal sulfides, transition metal oxysulfides, transition metal oxynitrides, sulfur, and lithium-containing compounds thereof are included. Examples of lithium-containing transition metal oxides include Li(NiCoAl)O₂, Li(NiCoMn)O₂, LiCoO₂, and the like. Li(NiCoAl)O₂ means that it contains any ratio of Ni, Co, and Al. Li(NiCoMn)O₂ means that it contains any ratio of Ni, Co, and Mn.

As the solid electrolyte, the solid electrolyte materials exemplified above can be used. In addition, as the conductive material used for the conductive aid, for example, conductive carbons such as acetylene black, carbon black, graphite, carbon fiber, vapor-deposited carbon, or carbon nanotubes are used. In addition, as the binder material, the binder materials exemplified above can be used.

The negative electrode active material layer may contain at least a negative electrode active material, and may include at least one of an electrolyte material such as a solid electrolyte, a conductive aid, or a binder material, if necessary.

As the negative electrode active material, known materials capable of absorbing and releasing (intercalating and deintercalating, or dissolving and precipitating) lithium ions, sodium ions, magnesium ions, or the like can be used. As the negative electrode active material, in the case of materials capable of deintercalating and intercalating lithium ions, carbon materials such as natural graphite, artificial graphite, graphite carbon fiber or resin-fired carbon, metal lithium, lithium alloy, silicon (Si), tin (Sn), silicon compounds, tin compounds or oxides of lithium and transition metal elements, and the like are used.

The solid electrolyte materials exemplified above can be used as the solid electrolyte. In addition, the conductive material exemplified above can be used as the conductive aid. In addition, the binder material illustrated above can be used as the binder material.

First insulating layer 22 includes one or more types of insulating materials having electronic insulation properties.

Insulating materials are materials that exhibit electronic insulation properties, that is, materials that have low electronic conductivity. Insulating materials include metal oxides such as silicon oxide, titanium oxide, and aluminum oxide, minerals such as mica and marble, heat dissipation fillers such as boron nitride, aluminum nitride, and beryllium oxide, resin particles such as latex particles and acrylic particles, and the like. In addition, resin materials such as silicone resin, epoxy resin, acrylic resin, or polyimide resin may be used as the insulating material.

In addition, first insulating layer 22 may contain a solid electrolyte as an insulating material. As the solid electrolyte, the solid electrolyte materials exemplified above may be used.

In addition, first insulating layer 22 may include a binder material as the insulating material. As the binder material, the binder material exemplified above may be used. The binder material included in first insulating layer 22 may be the same as the binder material used for electrode active material layer 21, or may be a different binder material.

In addition, the insulating material contained in first insulating layer 22 may contain an active material that exhibits insulating properties. Examples of active materials containing insulating properties include lithium iron phosphate, titanium oxide, lithium titanate, niobium titanium oxide, lithium vanadium oxide, and silicon.

The shape of the insulating material contained in first insulating layer 22 is not particularly limited. The insulating material may be needle-shaped, spherical, elliptical-spherical, or the like. The insulating material may be in the form of particulate form. In addition, first insulating layer 22 may be formed by curing a liquid resin material such as a thermosetting resin or an ultraviolet curable resin. In this case, a liquid resin material may be used in which particulate insulating material is dispersed.

First insulating layer 22 may contain the same material as solid electrolyte layer 31. In addition, first insulating layer 22 may have the same material configuration as solid electrolyte layer 31.

At least one layer selected from the group consisting of electrode active material layer 21, first insulating layer 22 and solid electrolyte layer 31 may contain a sulfide solid electrolyte. In addition, counter electrode active material layer 41 may contain a sulfide solid electrolyte. Since the solid sulfide electrolyte has excellent ionic conductivity, moldability and insulation properties, it is possible to achieve high output of the battery in addition to high resistance to short circuits of battery 1 and high efficiency productivity.

In addition, at least one layer selected from the group consisting of electrode active material layer 21, first insulating layer 22 and solid electrolyte layer 31 may contain a styrene-based elastomer. In addition, counter electrode active material layer 41 may contain a styrene-based elastomer. Since styrene-based elastomers have excellent flexibility and elasticity, the layer containing the styrene-based elastomer is less likely to collapse, and the high resistance to short circuits of battery 1 can be further improved.

Next, the end structure of unit cell 60 will be described.

As illustrated in FIG. 1 and FIG. 2, unit cell 60 is provided with first region 71, second region 72, third region 73, and fourth region 74 that are not covered with the upper layer at the end portion in the x-axis positive side direction (the end portion along side surface 61 in the example illustrated in FIG. 1).

Specifically, first region 71 not covered with first layer 20 is provided at the end portion of main surface 11 of electrode current collector 10 in the x-axis positive side direction. First region 71 is not in contact with first layer 20, second layer 30, third layer 40, and counter electrode current collector 50. In first region 71, main surface 11 of electrode current collector 10 is exposed. By providing first region 71, it is possible to easily form an electrical connection structure, such as terminals, on electrode current collector 10. In addition, when connecting a plurality of unit cells 60, first regions 71 on electrode current collector 10 can be bonded by welding or other methods, enabling a reduction in the resistance of the connection structure.

In addition, second region 72 not covered with second layer 30 in a plan view is provided at the end portion of first layer 20 in the x-axis positive side direction. Second region 72 is not in contact with second layer 30, third layer 40, and counter electrode current collector 50. Second region 72 is part of first insulating layer 22 of first layer 20 and does not include electrode active material layer 21 in the example illustrated in FIG. 1 and FIG. 2. In second region 72, first insulating layer 22 is exposed. By providing second region 72, the outer edge of second layer 30 is disposed inwards from the outer edge of first layer 20 in the x-axis positive side direction, and the end portion of second layer 30 is supported by first layer 20, thereby suppressing the collapse of second layer 30. In addition, at the end portion of unit cell 60, where first region 71 is provided, in the x-axis positive side direction, the outer edge of second layer 30 protruding beyond first layer 20 particularly increases the risk of collapse. However, by providing second region 72, even if the positioning accuracy during the formation of second layer 30 is not high, it is possible to avoid the outer edge of second layer 30 from protruding beyond first layer 20. For that reason, battery 1 can be manufactured with high efficiency while reducing the risk of collapse of second layer 30.

In addition, third region 73 not covered with third layer 40 in a plan view is provided at the end portion of second layer 30 in the x-axis positive side direction. Third region 73 is not in contact with third layer 40 and counter electrode current collector 50. Third region 73 is further away from electrode current collector 10 than second region 72. Second layer 30 is entirely composed of solid electrolyte layer 31, including the end portion in the x-axis positive side direction, and third region 73 is part of solid electrolyte layer 31. In third region 73, solid electrolyte layer 31 is exposed. By providing third region 73, the outer edge of third layer 40 is disposed inwards from the outer edge of second layer 30 in the x-axis positive side direction, so that the end portion of third layer 40 is supported by second layer 30, and the collapse of the end portion of third layer 40 can be suppressed. In addition, at the end portion of unit cell 60, where first region 71 is provided, in the x-axis positive direction, the possibility of collapse becomes particularly high when the outer edge of third layer 40 protrudes beyond second layer 30. However, by providing third region 73, even if the positioning accuracy during the formation of third layer 40 is not high, it is possible to prevent the outer edge of third layer 40 from protruding beyond second layer 30. For that reason, battery 1 can be manufactured with high efficiency while reducing the risk of collapse of third layer 40.

In addition, by providing third region 73, the distance between (i) counter electrode current collector 50 and counter electrode active material layer 41 and (ii) electrode current collector 10 becomes longer, and contact between (i) counter electrode current collector 50 and counter electrode active material layer 41 and (ii) electrode current collector 10 can be suppressed. In addition, since third region 73 is part of solid electrolyte layer 31, electronic insulation properties can be ensured at the end portion of second layer 30, and because there is no need to form another insulating layer to ensure such electronic insulation properties, second layer 30 can be formed all at once, allowing battery 1 to be manufactured at low cost and at high efficiency.

In addition, fourth region 74 not covered with counter electrode current collector 50 in a plan view is provided at the end portion of third layer 40 in the x-axis positive side direction. Fourth region 74 is further away from electrode current collector 10 than third region 73. Third layer 40 entirely includes counter electrode active material layer 41, including the end portion in the x-axis positive side direction, and fourth region 74 is part of counter electrode active material layer 41. In fourth region 74, counter electrode active material layer 41 is exposed. By providing fourth region 74, when counter electrode current collector 50 is stacked, contact between counter-electrode current collector 50 and the outer edge of third layer 40 in the x-axis positive side direction is suppressed, and the collapse of the end portion of third layer 40 can be suppressed. In addition, the distance between counter electrode current collector 50 and electrode current collector 10 becomes longer, and contact between counter electrode current collector 50 and electrode current collector 10 can be suppressed.

On the other hand, in conventional batteries, the structure is not provided with first region 71 to fourth region 74. For example, in the battery disclosed in PTL 3, the area corresponding to first region 71 is provided in the electrode current collector, and the area corresponding to third region 73 is provided in the solid electrolyte layer, but since the areas corresponding to second region 72 and fourth region 74 are not provided, the solid electrolyte layer and the counter electrode active material layer are likely to collapse. In addition, in order to suppress collapse, it is necessary to improve the positional accuracy of each layer, which makes it difficult to increase the efficiency of battery manufacturing.

In the example illustrated in FIG. 1, first region 71, second region 72, third region 73, and fourth region 74 are provided along side surface 61 in a plan view. First region 71, second region 72, third region 73, and fourth region 74 are elongated in a plan view, and in the example illustrated in FIG. 1, the direction perpendicular to the x-axis positive side direction (y-axis direction) is the longitudinal direction. In addition, fourth region 74, third region 73, second region 72, and first region 71 are arranged in this order in a plan view in the x-axis positive side direction.

In addition, although not shown, unit cell 60 may include an insulating tape or an insulating resin that covers at least part of first region 71, second region 72, third region 73, and fourth region 74. This can suppress collapse of portions covered with insulating tape or insulating resin among first layer 20, second layer 30 and third layer 40.

The length of first region 71 is, for example, at least 1 mm and at most 20 mm. This allows the energy density of battery 1 to be increased while ensuring a region in which an electrical connection structure such as terminals can be easily formed in electrode current collector 10.

The lengths of second region 72, third region 73, and fourth region 74 are, for example, at least 0.1 mm and at most 5 mm. This can enhance the effect of providing second region 72, third region 73, and fourth region 74 described above, and also increases the energy density of battery 1. The lengths of second region 72, third region 73 and fourth region 74 may be at least 0.5 mm and at most 2 mm.

The lengths of first region 71, second region 72, third region 73, and fourth region 74 may be the same as each other, or at least one of these may be different. In addition, the length of third region 73 may be longer than the lengths of second region 72 and fourth region 74. In addition, the length of first region 71 may be longer than the lengths of second region 72, third region 73, and fourth region 74.

Here, the lengths of first region 71, second region 72, third region 73, and fourth region 74 are the lengths in the x-axis positive side direction in a plan view. The length of first region 71 is also the distance in a plan view between the outer edge of electrode current collector 10 and the outer edge of first layer 20 in the x-axis positive side direction. The length of second region 72 is also the distance in a plan view between the outer edge of first layer 20 and the outer edge of second layer 30 in the x-axis positive side direction. The length of third region 73 is also the distance in a plan view between the outer edge of second layer 30 and the outer edge of third layer 40 in the x-axis positive side direction. The length of fourth region 74 is also the distance in a plan view between the outer edge of third layer 40 and the outer edge of counter electrode current collector 50 in the x-axis positive side direction.

In the present embodiment, electrode active material layer 21 may be a negative electrode active material layer, and counter electrode active material layer 41 may be a positive electrode active material layer. In the present embodiment, electrode active material layer 21 is larger than counter electrode active material layer 41, so metal ions are easily incorporated into electrode active material layer 21, which is the negative electrode active material layer, suppressing the precipitation of metals derived from metal ions, making it difficult for internal short circuits to occur, and the resistance of battery 1 to short circuits can be further enhanced.

With the configuration of battery 1 described above, it is possible to achieve both high resistance to short circuits and high efficiency productivity.

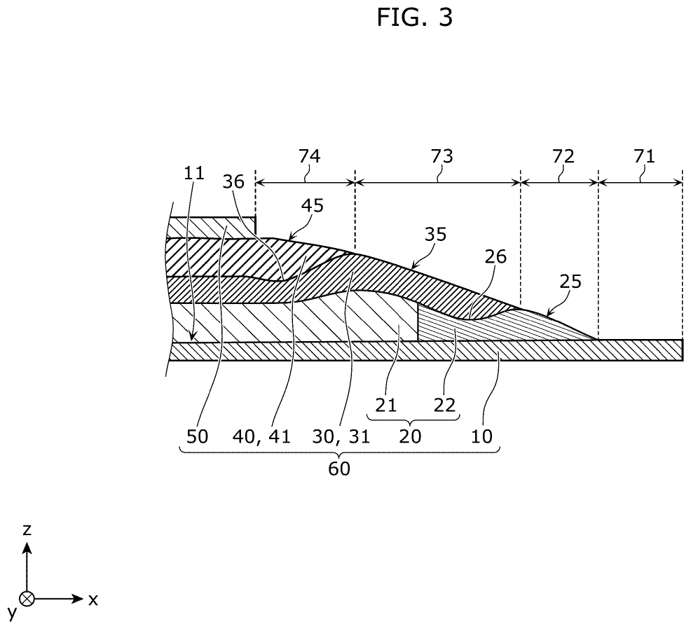

It should be noted that in the example illustrated in FIG. 1 and FIG. 2, electrode current collector 10, first layer 20, second layer 30, third layer 40 and counter electrode current collector 50 form a step-like structure at the end portion of unit cell 60 in the x-axis positive side direction, but the present disclosure is not limited thereto. FIG. 3 is a cross-sectional view illustrating another example of the end structure of unit cell 60.

In the example illustrated in FIG. 3, first layer 20 includes inclined surface 25 that is inclined in second region 72 so as to approach electrode current collector 10 as it extends in the x-axis positive side direction. Entire second region 72 is, for example, a region in which inclined surface 25 is formed. In addition, second layer 30 includes inclined surface 35 that is inclined in third region 73 so as to approach electrode current collector 10 as it extends in the x-axis positive side direction. Entire third region 73 is, for example, a region in which inclined surface 35 is formed. In addition, third layer 40 includes inclined surface 45 that is inclined in fourth region 74 so as to approach electrode current collector 10 as it extends in the x-axis positive side direction. Entire fourth region 74 is, for example, a region in which inclined surface 45 is formed. In the example illustrated in FIG. 3, inclined surface 25 and inclined surface 35 are connected, and inclined surface 35 and inclined surface 45 are connected. That is, inclined surfaces 25, 35 and 45 form one continuous inclined surface.

The formation of inclined surfaces 25, 35 and 45 makes it difficult for corners to be formed in first layer 20 of second region 72, second layer 30 of third region 73, and third layer 40 of fourth region 74, making it difficult for the materials in these layers to fall off, so that it becomes difficult for short circuits to occur.

The shape of these inclined surfaces can be formed, for example, by performing a high-pressure pressing treatment such as a roll press on the portion including the end portion of the stacked body in which first layer 20, second layer 30, and third layer 40 are stacked above electrode current collector 10 so that the end portions are in a step-like shape.

The angle formed by each of inclined surfaces 25, 35 and 45 with respect to main surface 11 is, for example, less than 45 degrees. This makes it more difficult for the layer material to fall off. The angle formed by each of inclined surfaces 25, 35 and 45 with respect to main surface 11 may be 30 degrees or less, or 10 degrees or less. In addition, the angle formed by each of inclined surfaces 25, 35 and 45 with respect to main surface 11 is, for example, one degree or more.

In addition, in the example illustrated in FIG. 3, first layer 20 includes recess 26 in which second layer 30 in third region 73 is embedded. In addition, second layer 30 includes recess 36 in which third layer 40 in fourth region 74 is embedded. This increases the bonding strength of the layers stacked above and below at the end portions in the x-axis positive side direction, making it difficult for the materials of these layers to fall off, and delamination is also suppressed. For that reason, short circuits due to contact of different polarity electrodes are less likely to occur. This embedded shape can be formed, for example, by performing a high-pressure pressing treatment such as a roll press on the portion including the end portion of the stacked body in which first layer 20, second layer 30, and third layer 40 are stacked on electrode current collector 10 so that the end portions are in a step-like shape.

The depth of each of recesses 26 and 36 is, for example, at least 1 μm and at most 10 μm.

In addition, in the example illustrated in FIG. 3, the surface of first layer 20 on second layer 30 side at the lower side of inclined surface 45 (that is, the position overlapping with inclined surface 45 in a plan view) includes a portion that is inclined so as to be away from electrode current collector 10 as it extends in the x-axis positive side direction. For that reason, at a position of the outer edge of third layer 40 in the x-axis positive side direction in a plan view, the thickness of first layer 20 (electrode active material layer 21 in the example illustrated in FIG. 3) is greater than the thickness of first layer 20 at a position further inward than that position.

It should be noted that the structure of the end portions of first layer 20, second layer 30, and third layer 40 illustrated in FIG. 3 in the x-axis positive side direction may be included in the batteries according to Embodiments and respective Variations described below.

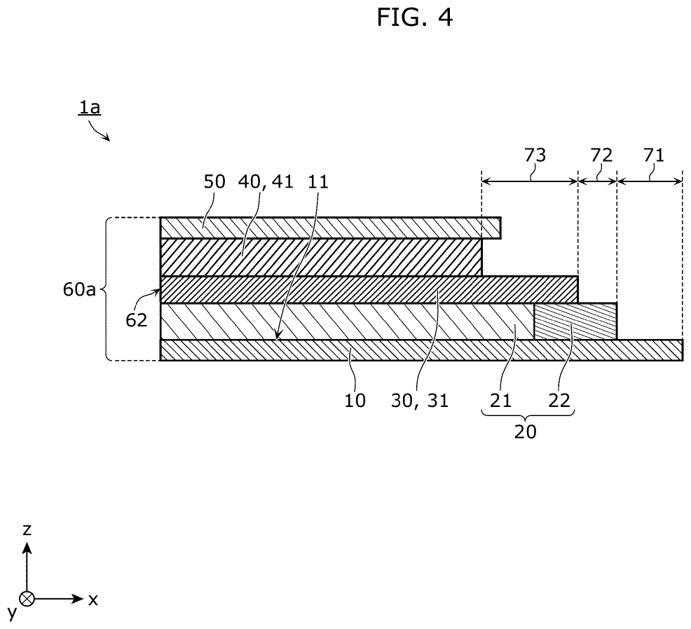

In addition, in the example illustrated in FIG. 1 and FIG. 2, fourth region 74 is provided in third layer 40, but the present disclosure is not limited thereto. Fourth region 74 may not be provided in third layer 40. FIG. 4 is a cross-sectional view of another battery 1a according to the present embodiment.

As illustrated in FIG. 4, battery 1a includes unit cell 60a and is formed from one unit cell 60a. Unit cell 60a differs from unit cell 60 in that fourth region 74 is not provided in third layer 40.

In unit cell 60a, counter electrode current collector 50 completely covers third layer 40 in a plan view, and fourth region 74 as mentioned above is not provided at the end portion of third layer 40 in the x-axis positive side direction. This reduces the contact resistance between counter electrode active material layer 41 included in third layer 40 and counter electrode current collector 50, and enables battery 1a to be increased. In the example illustrated in FIG. 4, counter electrode current collector 50 protrudes in the x-axis positive side direction from the outer edge of third layer 40 in a plan view, but the outer edge of third layer 40 and the outer edge of counter electrode current collector 50 in the x-axis positive side direction may be aligned.

It should be noted that the structure in which fourth region 74 is not provided in third layer 40 as illustrated in FIG. 4 may be provided by a battery including third layer 40 among the batteries according to the embodiment and each variation described below.

### [2. Variations]

In the following, batteries according to variations of the present embodiment will be described. It should be noted that in the following description of the variations, differences between Embodiment 1 and respective Variations will be mainly described, and descriptions of commonalities will be omitted or simplified.

### [2-1. Variation 1]

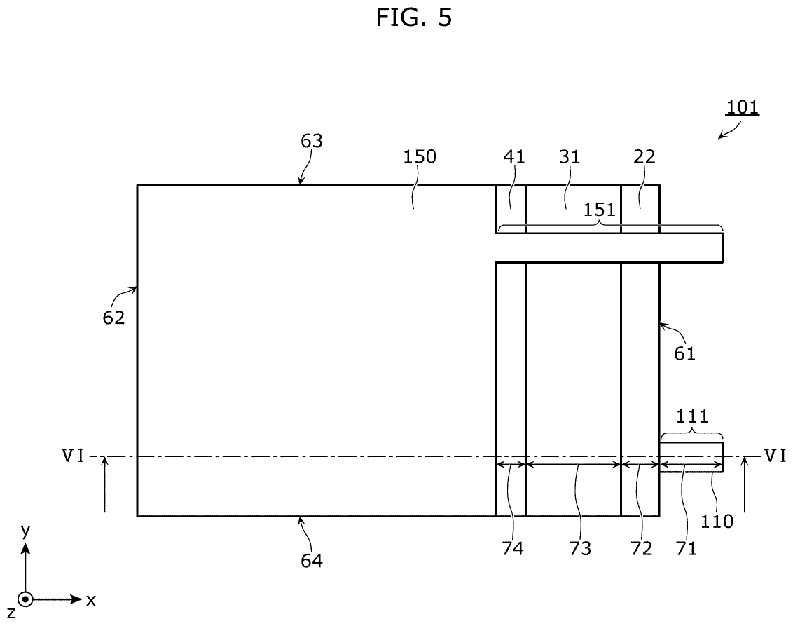

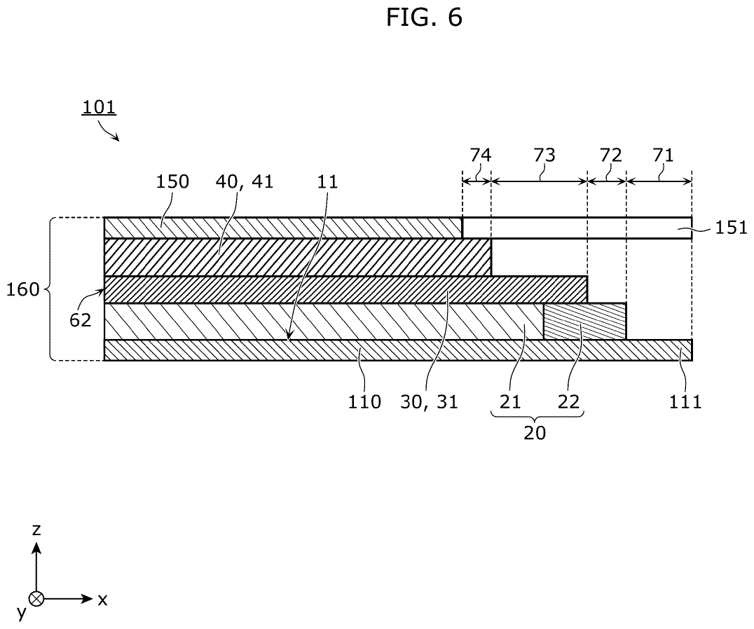

First, a battery according to Variation 1 of Embodiment 1 will be described. FIG. 5 is a top view of battery 101 according to the present variation. FIG. 6 is a cross-sectional view of battery 101 according to the present variation. FIG. 5 shows the shape of battery 101 when viewed from the z-axis positive side. In addition, FIG. 6 is a cross-sectional view at the position illustrated by line VI-VI in FIG. 5.

As illustrated in FIG. 5 and FIG. 6, battery 101 includes unit cell 160 and is formed from one unit cell 160. Compared to unit cell 60 according to Embodiment 1, unit cell 160 is different in that electrode current collector 110 and counter electrode current collector 150 are provided in place of electrode current collector 10 and counter electrode current collector 50.

Electrode current collector 110 includes protrusion 111 which is a portion where part of the end portion of electrode current collector 110 in the x-axis positive side direction protrudes in the x-axis positive side direction than other parts. Electrode current collector 110 has a shape in which rectangular tab-shaped protrusion 111 is provided on electrode current collector 10 mentioned above, whose shape is rectangular in a plan view. Protrusion 111 functions, for example, as a lead for making electrical connections. Another lead material may be further bonded to protrusion 111. In the example illustrated in FIG. 5 and FIG. 6, first region 71 is provided only in a portion of protrusion 111 of main surface 11 of electrode current collector 110, but may also be provided inside protrusion 111 of electrode current collector 110. In addition, in a plan view, part of protrusion 111 may be covered with first insulating layer 22 of first layer 20. In addition, in the example illustrated in FIG. 5 and FIG. 6, in a plan view, the position of the outer edge of electrode current collector 110 in the portion other than protrusion 111 in the x-axis positive side direction and the position of the outer edge of first layer 20 in the x-axis positive side direction are coincident. It should be noted that first insulating layer 22 of first layer 20 may cover the end surface of electrode current collector 110 in the x-axis positive side direction. In addition, electrode current collector 110 may not include protrusion 111. That is, instead of electrode current collector 110, electrode current collector 10 in which first region 71 is provided, may be used.

Counter electrode current collector 150 includes protrusion 151 which is a portion where part of the end portion of counter electrode current collector 150 in the x-axis positive side direction protrudes in the x-axis positive side direction than other parts. Counter electrode current collector 150 has a shape in which rectangular tab-shaped protrusion 151 is provided on counter electrode current collector 50 mentioned above, whose shape is rectangular in a plan view. Protrusion 151 protrudes more in the x-axis positive side direction than third layer 40 in a plan view. Protrusion 151 functions, for example, as a lead for making electrical connections. Yet another lead material may be further bonded to protrusion 151.

Protrusion 151 faces electrode current collector 410 through first insulating layer 22. In addition, protrusion 111 and protrusion 151 are arranged at positions where they do not overlap in a plan view. It should be noted that first insulating layer 22 may not be formed in a position where it does not overlap with protrusion 151 in a plan view.

In this way, in battery 101, protrusion 151, which is part of the end portion of counter electrode current collector 150 in the x-axis positive side direction, protrudes more in the x-axis positive side direction than third layer 40 in a plan view. This enables the electrical connection structure such as terminals to be formed on counter electrode current collector 150 at the end portion of battery 101, and the structure becomes less complicated than when an electrical connection structure is formed on the main surface of counter electrode current collector 150. In addition, even if counter electrode current collector 150 includes protrusion 151, first insulating layer 22 is disposed at the end portion of first layer 20 in the x-axis positive side direction, so that short circuits due to contact between (i) protrusion 151 and (ii) electrode active material layer 21 and electrode current collector 110 are suppressed.

### [2-2. Variation 2]

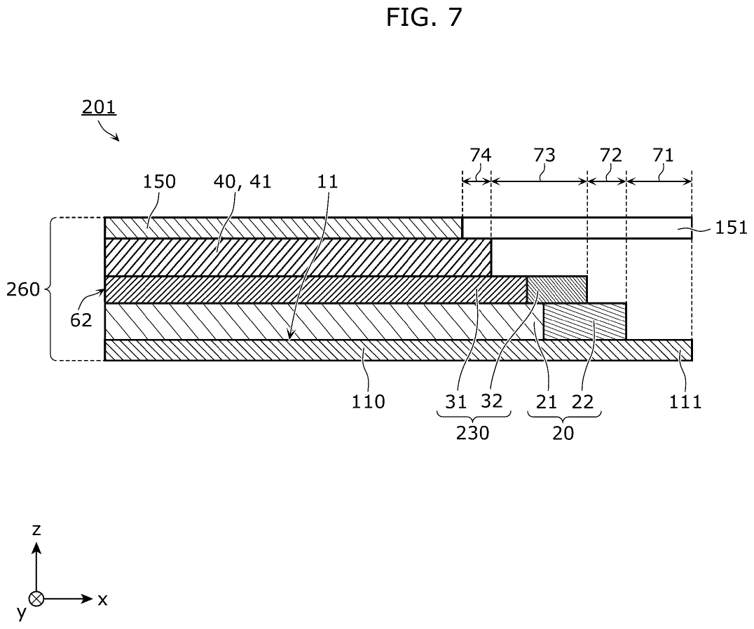

Next, a battery according to Variation 2 of Embodiment 1 will be described. FIG. 7 is a cross-sectional view of battery 201 according to the present variation.

As illustrated in FIG. 7, battery 201 includes unit cell 260 and is formed from one unit cell 260. Compared with unit cell 160 according to Variation 1 of Embodiment 1, unit cell 260 is different in that second layer 230 is provided instead of second layer 30.

Second layer 230 includes solid electrolyte layer 31 and second insulating layer 32 aligned with solid electrolyte layer 31 in the x-axis positive side direction and disposed at the end portion of second layer 230 in the x-axis positive side direction. The thickness of second insulating layer 32 is, for example, at least 5 μm and at most 150 μm. The thickness of solid electrolyte layer 31 and the thickness of second insulating layer 32 are, for example, substantially the same. The thickness of second insulating layer 32 may be smaller than the thickness of solid electrolyte layer 31.

Second insulating layer 32 has electronic insulating properties. Second insulating layer 32 may further have ionic insulating properties. Second insulating layer 32 is in contact with the surface of first layer 20 on the second layer 230 side and the end surface of solid electrolyte layer 31 in the x-axis positive side direction. By placing second insulating layer 32 at the end portion of second layer 230, collapse of solid electrolyte layer 31 can be suppressed. In addition, when second insulating layer 32 has ionic insulation, second insulating layer 32 suppresses the conduction of ions to solid electrolyte layer 31 due to contact between the electrolyte and the like of another battery and solid electrolyte layer 31, and unexpected movement of ions in battery 201 can be suppressed.

Second insulating layer 32 extends on first layer 20 in the direction (y-axis direction) in which the end surface of solid electrolyte layer 31 extends in the x-axis positive side direction. Second insulating layer 32 includes a portion that does not overlap with solid electrolyte layer 31 in a plan view. In addition, second insulating layer 32 is provided along the entire end portion of solid electrolyte layer 31 in the x-axis positive side direction, but may be provided at a part of the end portion of solid electrolyte layer 31 in the x-axis positive side direction. For example, second insulating layer 32 may not be formed in a position where it does not overlap with protrusion 151 in a plan view.

Second insulating layer 32 includes one or more types of insulating materials having electronic insulating properties. As the insulating material, the insulating material exemplified above used for first insulating layer 22 can be used. Second insulating layer 32 may include a sulfide solid electrolyte. In addition, second insulating layer 32 may include a styrene-based elastomer.

Second insulating layer 32 may contain the same material as first insulating layer 22. In addition, second insulating layer 32 may have the same material configuration as first insulating layer 22.

In unit cell 260, at the end portion of second layer 230 in the x-axis positive side direction, in a plan view, a portion of solid electrolyte layer 31 and second insulating layer 32 are not covered with third layer 40. For that reason, third region 73 is formed of part of solid electrolyte layer 31 and part of second insulating layer 32. In third region 73, solid electrolyte layer 31 and second insulating layer 32 are exposed. Third layer 40 may completely cover solid electrolyte layer 31 in a plan view, and third region 73 may be made up of only a part of second insulating layer 32.

It should be noted that second layer 230 may be used in place of second layer 30 in the batteries according to the embodiment and each variation exemplified above or described below.

### [2-3. Variation 3]

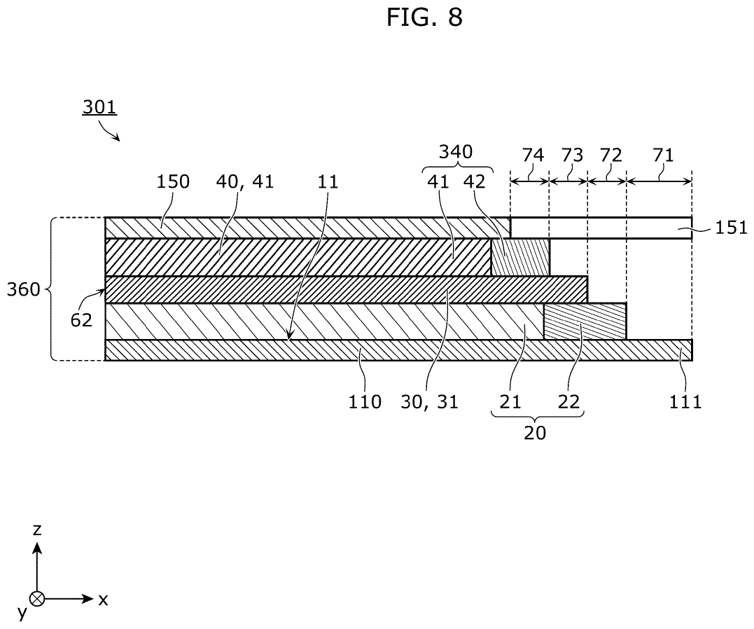

Next, a battery according to Variation 3 of Embodiment 1 will be described. FIG. 8 is a cross-sectional view of battery 301 according to the present variation.

As illustrated in FIG. 8, battery 301 includes unit cell 360 and is formed from one unit cell 360. Compared with unit cell 160 according to Variation 1 of Embodiment 1, unit cell 360 is different in that unit cell 360 includes third layer 340 in place of third layer 40.

Third layer 340 includes counter electrode active material layer 41 and third insulating layer 42 that is aligned with counter electrode active material layer 41 in the x-axis positive side direction and is disposed at the end portion of third layer 340 in the x-axis positive side direction. The thickness of third insulating layer 42 is, for example, at least 5 μm and at most 300 μm. The thickness of counter electrode active material layer 41 and the thickness of third insulating layer 42 are, for example, substantially the same. The thickness of third insulating layer 42 may be smaller than the thickness of counter electrode active material layer 41.

Third insulating layer 42 has electronic insulation properties. Third insulating layer 42 may further have ionic insulating properties. Third insulating layer 42 is in contact with the surface of second layer 30 on the third layer 340 side and the end surface of counter electrode active material layer 41 in the x-axis positive side direction. By placing third insulating layer 42 at the end portion of third layer 340, contact of the electrode with the different polarity to counter electrode active material layer 41 can be suppressed, and resistance to short circuits of battery 301 can be improved. In addition, collapse of counter electrode active material layer 41 can be suppressed.

Third insulating layer 42 extends on second layer 30 in the direction (y-axis direction) in which the end surface of counter electrode active material layer 41 extends in the x-axis positive side direction. Third insulating layer 42 includes a portion that does not overlap with counter electrode active material layer 41 in a plan view. In addition, third insulating layer 42 is provided along the entire end portion of counter electrode active material layer 41 in the x-axis positive side direction, but may be provided at a part of the end portion of counter electrode active material layer 41 in the x-axis positive side direction. For example, third insulating layer 42 may not be formed in a position where it does not overlap with protrusion 151 in a plan view.

Third insulating layer 42 includes one or more types of insulating materials having electronic insulating properties. As the insulating material, the insulating material exemplified above used for first insulating layer 22 can be used. Third insulating layer 42 may include a sulfide solid electrolyte. In addition, third insulating layer 42 may include a styrene-based elastomer.

Third insulating layer 42 may contain the same material as first insulating layer 22. In addition, third insulating layer 42 may have the same material configuration as first insulating layer 22.

In unit cell 360, at the end portion of third layer 340 in the x-axis positive side direction, part of third insulating layer 42 is not covered with counter electrode current collector 150 in a plan view. For that reason, fourth region 74 is part of third insulating layer 42. Accordingly, the outer edge of counter electrode current collector 150 in the x-axis positive side direction is supported by third insulating layer 42, so that collapse of counter electrode active material layer 41 can be suppressed. In addition, counter electrode current collector 150 completely covers counter electrode active material layer 41 in a plan view. This reduces the contact resistance between counter electrode active material layer 41 and counter electrode current collector 150, and enables battery 301 to be increased. Counter electrode current collector 150 does not need to be covered with third insulating layer 42 in a plan view.

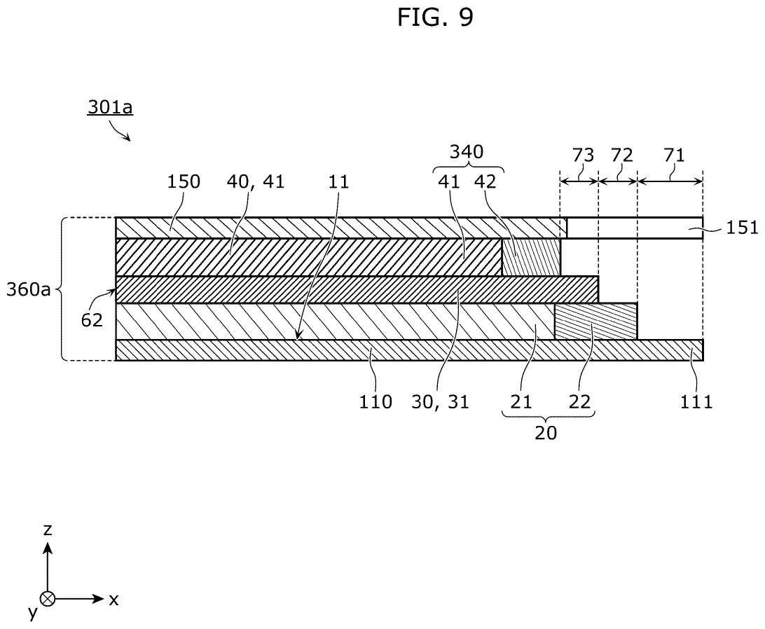

It should be noted that in the example illustrated in FIG. 8, fourth region 74 is provided in third layer 340, but the present disclosure is not limited thereto. Third layer 340 may not be provided with fourth region 74. FIG. 9 is a cross-sectional view of another battery 301a according to the present variation.

As illustrated in FIG. 9, battery 301a includes unit cell 360a and is formed from one unit cell 360a. Unit cell 360a is different from unit cell 360 in that fourth region 74 is not provided in third layer 340.

In unit cell 360a, counter electrode current collector 150 completely covers third layer 340 in a plan view, and fourth region 74 as mentioned above is not provided at the end portion of third layer 340 in the x-axis positive side direction. In the example illustrated in FIG. 9, counter electrode current collector 150 protrudes in the x-axis positive side direction relative to the outer edge of third layer 340 in a plan view, but the outer edge of third layer 340 in the x-axis positive side direction and the outer edge of counter electrode current collector 150 at a location other than protrusion 151 may be aligned.

It should be noted that third layer 340 provided with fourth region 74, or third layer 340 provided without fourth region 74 may be used in place of third layer 40 in the batteries according to the embodiment and each variation exemplified above or described below.

### [2-4. Variation 4]

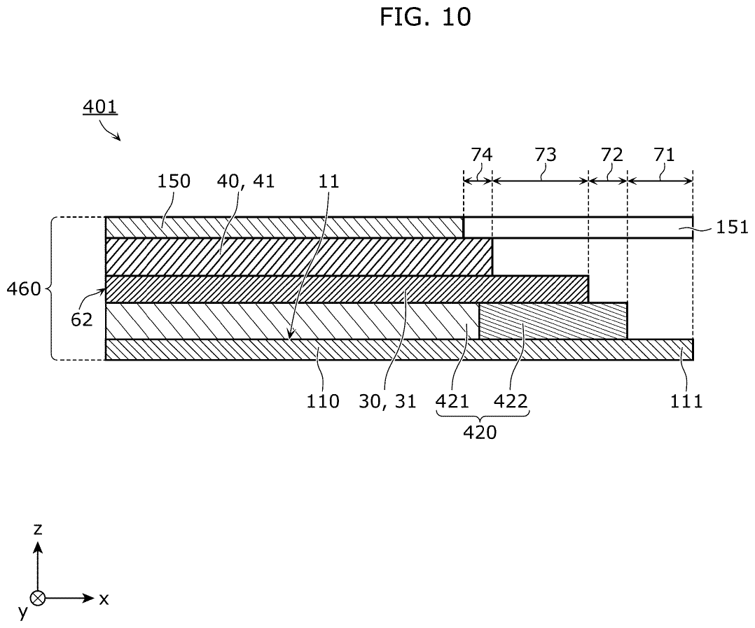

Next, a battery according to Variation 4 of Embodiment will be described. FIG. 10 is a cross-sectional view of battery 401 according to the present variation.

As illustrated in FIG. 10, battery 401 includes unit cell 460 and is formed from one unit cell 460. Compared with unit cell 160 according to Variation 1 of Embodiment 1, unit cell 460 is different in that unit cell 460 includes first layer 420 in place of first layer 20.

First layer 420 includes electrode active material layer 421 and first insulating layer 422 of different sizes from electrode active material layer 21 and first insulating layer 22 of first layer 20. In a plan view, the area of electrode active material layer 421 is smaller than the area of counter electrode active material layer 41. In a plan view, the outer edge of electrode active material layer 421 in the x-axis positive side direction is located inside the outer edge of counter electrode active material layer 41 in the x-axis positive side direction. For that reason, the length of first insulating layer 422 in the x-axis positive side direction is increased, and first insulating layer 422 can enhance the effect of suppressing contact of the electrode with the different polarity to electrode active material layer 421.

In the present variation, electrode active material layer 421 may be a positive electrode active material layer, and counter electrode active material layer 41 may be a negative electrode active material layer. In the present variation, counter electrode active material layer 41 is larger than electrode active material layer 421, so metal ions are easily incorporated into counter electrode active material layer 41, which is the negative electrode active material layer, suppressing the precipitation of metals derived from metal ions, making it difficult for internal short circuits to occur, and the resistance of battery 401 to short circuits can be further enhanced.

It should be noted that first layer 420 may be used in place of first layer 20 in the batteries according to the embodiments and variations exemplified above or described below.

### [2-5. Variation 5]

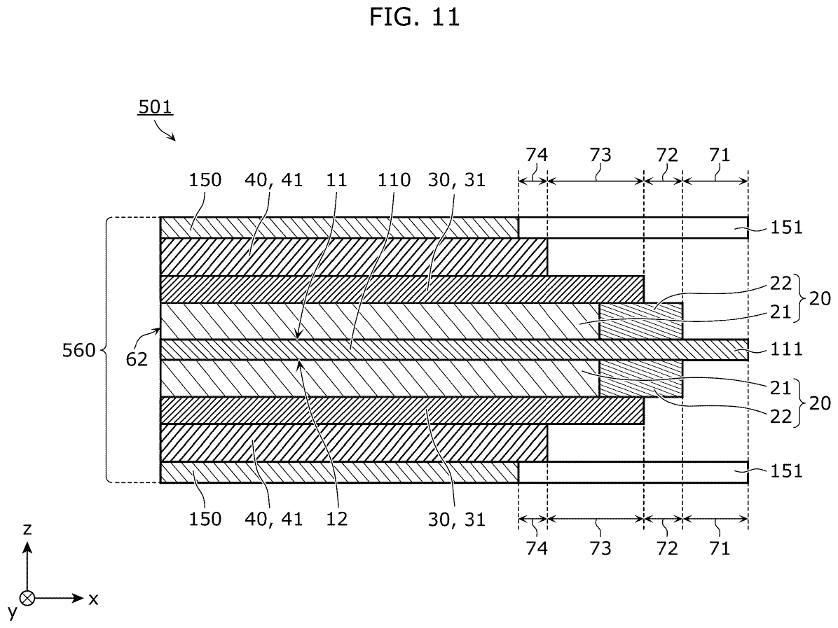

Next, a battery according to Variation 5 of Embodiment 1 will be described. FIG. 11 is a cross-sectional view of battery 501 according to the present variation.

As illustrated in FIG. 11, battery 501 includes unit cell 560 and is formed from one unit cell 560. Compared to unit cell 160 according to Variation 1 of Embodiment 1, unit cell 560 is different in that it includes two first layers 20, two second layers 30, two third layers 40, and two counter electrode current collectors 150.

As illustrated in FIG. 11, two first layers 20 are respectively disposed on both main surfaces 11 and 12 of electrode current collector 110. Two second layers 30 are disposed on the sides of two first layers 20 opposite from electrode current collector 110. Two third layers 40 are disposed on two respective second layers 30 opposite from first layers 20. Two counter electrode current collectors 150 are disposed on two respective third layers 40 opposite from second layers 30.

In addition, as illustrated in FIG. 11, first region 71 not covered with any of two first layers 20 is provided at the end portion of each of both main surfaces 11 and 12 of electrode current collector 110 in the x-axis positive side direction. At the end portion of each of two first layers 20 in the x-axis positive side direction, second region 72 not covered with any of two second layers 30 is provided. At the end portion of each of two second layers 30 in the x-axis positive side direction, third region 73 not covered with any of two third layers 40 is provided. At the end portion of each of two third layers 40 in the x-axis positive side direction, fourth region 74 not covered with any of two counter electrode current collectors 150 is provided.

In this way, in unit cell 560, a structure similar to the stacked structure of first layer 20, second layer 30, third layer 40, and counter electrode current collector 150 formed on main surface 11 of electrode current collector 110 of unit cell 160 is also formed upside down on main surface 12 facing away from main surface 11 of electrode current collector 110. For that reason, unit cell 560 has a symmetrical stacked structure with electrode current collector 110 interposed therebetween.

Accordingly, when unit cell 560 is densified by pressing or other means, a difference in the stress applied on both sides of electrode current collector 110 in the stacking direction is less likely to occur, thereby suppressing warping of the unit cell. In addition, when battery 501 is used, even if stresses occur due to expansion and contraction of electrode active material layer 21 and counter electrode active material layer 41, differences in stresses occurring on both sides of electrode current collector 110 in the stacking direction are unlikely to occur, and warping of unit cell 560 can be suppressed. In addition, since currents from the two electrode active material layers 21 can be extracted from one electrode current collector 110, the volume energy density can be increased.

It should be noted that in unit cell 560 according to the present variation, a stacked structure formed on main surface 11 of unit cell 160 is also formed on main surface 12, but instead of unit cell 160, a stacked structure formed on main surface 11 of the unit cell according to the embodiment and each variation described above other than unit cell 160 may also be formed on main surface 12 of that unit cell 12.

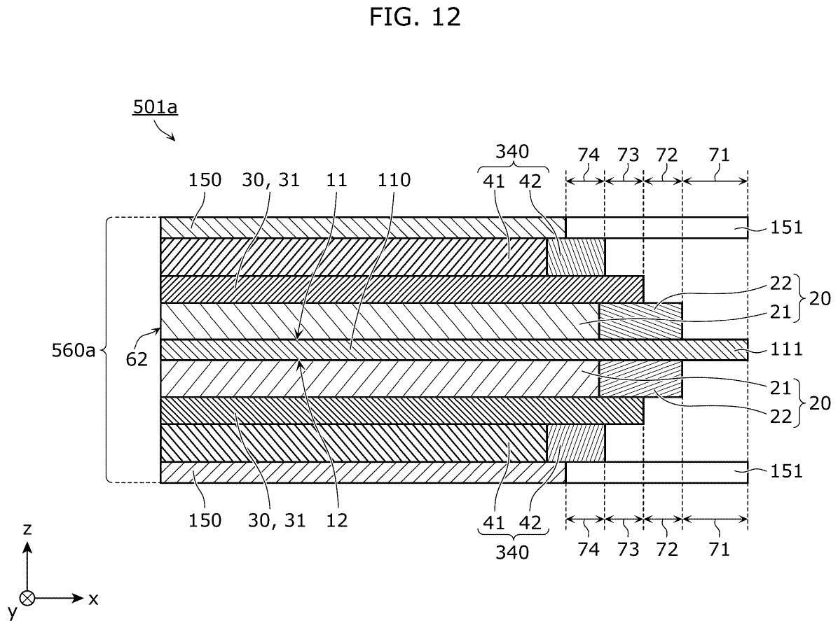

An example of a battery in which the stacked structure formed on main surface 11 of the unit cell other than unit cell 560 is also formed on main surface 12 will be described with reference to FIG. 12. FIG. 12 is a cross-sectional view of another battery 501a according to the present variation. As illustrated in FIG. 12, battery 501a includes unit cell 560a and is formed of one unit cell 560a. In unit cell 560a, a structure similar to the stacked structure of first layer 20, second layer 30, third layer 340, and counter electrode current collector 150 formed on main surface 11 of electrode current collector 110 of unit cell 360 is also formed on main surface 12 facing away from main surface 11 of electrode current collector 110. This allows the same effect as battery 501 described above to be obtained.

### [2-6. Variation 6]

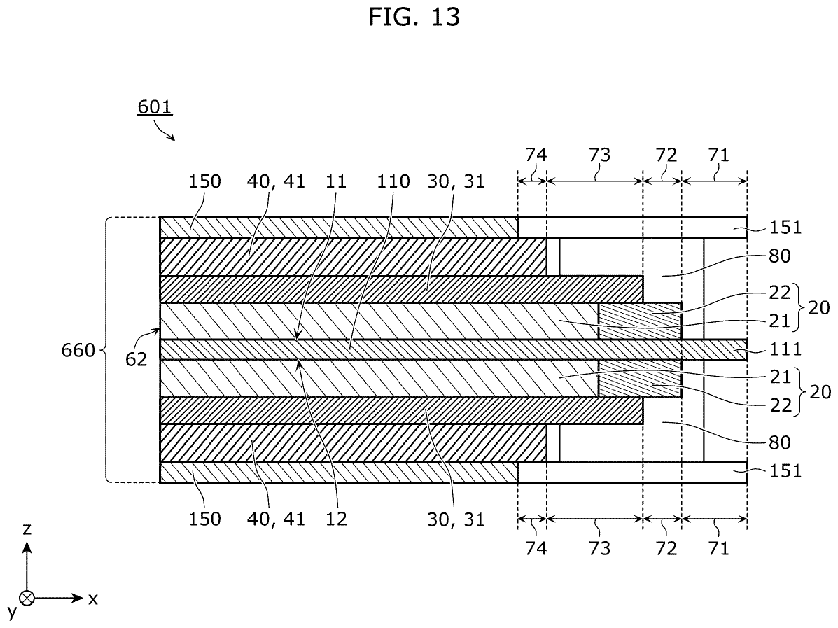

Next, a battery according to Variation 6 of Embodiment 1 will be described. FIG. 13 is a cross-sectional view of battery 601 according to the present variation. In FIG. 13, the outline of insulating member 80 at a position where protrusions 111 are not formed is illustrated by dashed lines.

As illustrated in FIG. 13, battery 601 includes unit cell 660 and is formed from one unit cell 660. Unit cell 660 is different from unit cell 560 according to Variation 5 of Embodiment 1 in that it further includes insulating member 80.

Insulating member 80 covers the end surface of electrode current collector 110 in the x-axis positive side direction, except where protrusion 111 is formed. In addition, insulating member 80 further covers the end surface of first layer 20 in the x-axis positive side direction. For example, insulating member 80 is provided in the y-axis positive and y-axis negative directions of protrusion 111. This further suppresses short circuits caused by contact between protrusion 151 and electrode current collector 110. In addition, in the example illustrated in FIG. 13, insulating member 80 covers the entire region of second region 72 and part of third region 73 on the second region 72 side. Insulating member 80 does not cover part of third region 73. A gap is provided between third layer 40 and insulating member 80. It should be noted that insulating member 80 only needs to cover the portion of the end surface in the x-axis positive side direction of electrode current collector 110 that overlaps with protrusion 151 in a plan view, and it does not need to cover other portions. In addition, insulating member 80 may cover part of first region 71. In addition, insulating member 80 may cover the entire region of third region 73. In addition, insulating member 80 may cover at least part of fourth region 74.

Insulating member 80 has electronic and ionic insulation properties. For example, an insulating tape, an insulating resin, or the like is used for insulating member 80. Examples of resins used for the component members of the insulating tape and the insulating resin include silicone resin, epoxy resin, acrylic resin, polyimide resin, and the like. The resin may be a thermosetting resin or an ultraviolet curable resin.

### [3. Manufacturing Method]

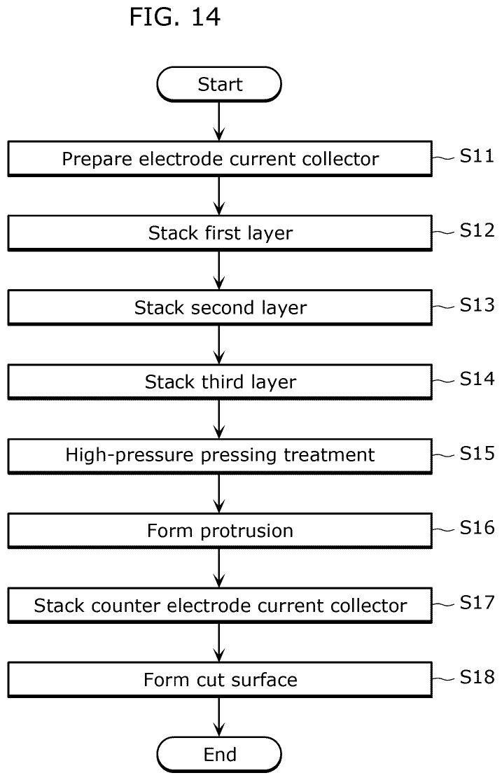

Next, a battery manufacturing method according to the present embodiment and each variation of the present embodiment will be described. The following description will focus on the manufacturing method of battery 501 according to Variation 5 of Embodiment 1, but other batteries can also be manufactured by appropriately applying the following manufacturing method. FIG. 14 is a flow chart illustrating a manufacturing method of battery 501 according to Variation 5 of Embodiment 1. It should be noted that the manufacturing method of battery 501 described below is an example, and the manufacturing method of battery 501 is not limited to the following example.

First, in the manufacturing method of battery 501, electrode current collector 10 in which protrusion 111 is not formed is prepared (step S11). Next, first layer 20 is stacked on both main surfaces 11 and 12 of electrode current collector 10 (step S12). At this time, first layer 20 is stacked on main surfaces 11 and 12 so that first region 71 not covered with first layer 20 is provided at the end portions of main surfaces 11 and 12 in the x-axis positive side direction. Accordingly, even if the forming position of first layer 20 shifts slightly, first layer 20 does not protrude from main surface 11, so that first layer 20 can be formed with high efficiency without excessively increasing the positional accuracy of first layer 20. It should be noted that when a battery is manufactured where no first layer 20 or the like is stacked on main surface 12 side of battery 1 and the like, first layer 20 is stacked only on main surface 11.

Next, second layer 30 is stacked on the side of first layer 20 opposite from electrode current collector 10 (step S13). At this time, second layer 30 is stacked on first layer 20 so that second region 72 not covered with second layer 30 is provided at the end portion of first layer 20 in the x-axis positive side direction. Accordingly, even if the forming position of second layer 30 shifts slightly, second layer 30 does not protrude from first layer 20, so that second layer 30 can be formed with high efficiency without excessively increasing the positional accuracy of second layer 30.

Next, third layer 40 is stacked on the side of second layer 30 opposite from first layer 20 (step S14). At this time, third layer 40 is stacked on second layer 30 so that third region 73 not covered with third layer 40 is provided at the end portion of second layer 30 in the x-axis positive side direction. Accordingly, even if the forming position of third layer 40 shifts slightly, third layer 40 does not protrude from second layer 30, so that third layer 40 can be formed with high efficiency without excessively increasing the positional accuracy of third layer 40.

When stacking first layer 20, second layer 30, and third layer 40, high-pressure pressing treatment (step S15) is performed after each step from step S12 to step S14 as necessary. This results in a stacked electrode plate in which first layer 20, second layer 30, and third layer 40 are stacked on both main surfaces 11 and 12 of electrode current collector 10 in this order from the sides of main surfaces 11 and 12.

First layer 20, second layer 30, and third layer 40 are each formed in order, for example, by a wet coating method. By using a wet coating method, first layer 20, second layer 30 and third layer 40 can be easily stacked to electrode current collector 10. As the wet coating method, coating methods such as die coating, doctor blade, roll coater, screen printing, or ink jet coating methods are used, but the present disclosure is not limited to these methods.

When wet coating is used, a coating formulation process is performed to obtain a slurry by appropriately mixing the materials that form electrode active material layer 21, first insulating layer 22, solid electrolyte layer 31, and counter electrode active material layer 41 with a solvent. A liquid resin material may be prepared instead of the slurry as the material for first insulating layer 22.

The solvent used in the coating formulation process may employ a solvent known to be used in the fabrication of a known all-solid-state battery (for example, a lithium-ion all-solid-state battery).

The layer coating process of the slurry of each layer obtained in the coating formulation process is performed on both main surfaces 11 and 12 of electrode current collector 10 in the order of first layer 20, second layer 30 and third layer 40. At this time, after the layer coating process of the layer the layer coating process of which is performed earlier is completed, the layer coating process of the next layer may be performed, or on the way of the layer coating process of the layer the layer coating process of which is performed earlier, the layer coating process of the next layer may be started. That is, steps S12, S13 and S14 may be performed simultaneously. In addition, when the layer coating process of first layer 20 including two types of layers is performed, for example, by using a die capable of discharging two types of slurry, or the like, electrode active material layer 21 and first insulating layer 22 are simultaneously coated. The coating direction at this time is a direction perpendicular to the direction in which electrode active material layer 21 and first insulating layer 22 are arranged. It should be noted that electrode active material layer 21 and first insulating layer 22 may be sequentially coated. In addition, when second layer 230 and third layer 340 including two types of layers are formed, similarly to first layer 20, second layer 230 and third layer 340 can be formed in the same manner as first layer 20.

The layer coating process of the slurry of each layer is sequentially performed, and after all the layers are coated, a high-pressure pressing treatment (step S15) is carried out to promote filling of the material of each layer. It should be noted that the high-pressure pressing treatment may be performed for each coating of the layer. For example, in the coating layering processes of first layer 20, second layer 30, and third layer 40, the high-pressure pressing treatment may be performed for each coating layering process of one layer, may be performed separately after the coating layering processes of any two layers and after the coating layering process of one layer, or may be performed collectively after the coating layering processes of all three layers. If the high-pressure pressing treatment is carried out more than once, the pressing may be performed so that the pressure of the final high-pressure pressing treatment is at the highest. In addition, for the high-pressure pressing treatment, for example, a roll press, a flat plate press, an isotropic press (ISP), or the like is used.

In addition, when a wet coating method is used, a heat treatment is performed to remove the solvent before the high-pressure pressing treatment. The heat treatment is performed, for example, after each coating of first layer 20, second layer 30, and third layer 40, but may be performed collectively after first layer 20, second layer 30, and third layer 40 are stacked. It should be noted that at least one of the heat treatment or the high pressure pressing treatment may not be performed.

By performing the layer coating method in this way, the bondability of the interfaces between electrode current collector 10, first layer 20, second layer 30, and third layer 40 can be improved and the interface resistance can be reduced. In addition, bondability can be improved and grain boundary resistance can be reduced in the powder materials used for first layer 20, second layer 30 and third layer 40. That is, good interfaces are formed between layers of first layer 20, second layer 30, and third layer 40, and between the powder materials inside the layers.

It should be noted that steps S12 to S15 may be performed in a series of continuous processes such as a roll to roll method.

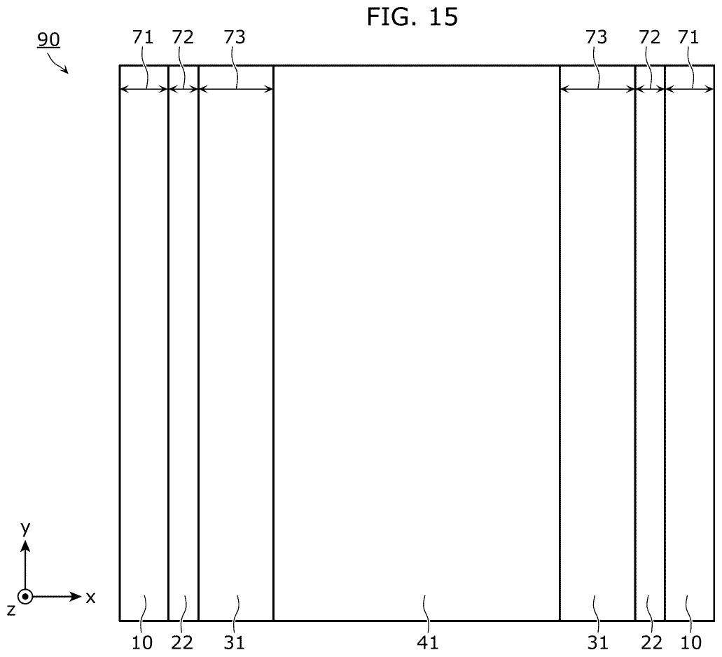

In addition, the stacked electrode plate may be in a size that corresponds to one battery 501 in a plan view, or may be in a size in a plan view that can be fragmented and used for a plurality of batteries 501. FIG. 15 is a top view illustrating an example of stacked electrode plate 90. As illustrated in FIG. 15, stacked electrode plate 90 is provided with first regions 71, second regions 72 and third regions 73 formed at end portions of the x-axis on both positive and negative sides. In addition, first insulating layer 22 of first layer 20 is located at the end portions of first layer 20 on both the positive and negative sides of the x-axis. In addition, stacked electrode plate 90 includes two first layers 20, two second layers 30, and two third layers 40, and first layers 20, second layers 30, and third layers 40 are disposed on both sides of electrode current collector 10 in the stacking direction. FIG. 15 illustrates first layer 20, second layer 30, and third layer 40 that are disposed on one side (the positive side of the z-axis) of electrode current collector 10 in the stacking direction.

Battery 501 can be manufactured by proceeding with the manufacturing process of battery 501 using such stacked electrode plate 90, and by fragmenting stacked electrode plate 90 into the shape of one battery 501 at any stage until battery 501 is completed. This can improve manufacturing efficiency. For example, stacked electrode plate 90 is fragmented by cutting it in the y-axis direction at least in the center of stacked electrode plate 90 of the x-axis direction. In addition, this fragmentation may be performed by cutting in step S18, which will be described later. In addition, after stacked electrode plate 90 is fragmented, polishing or the like may be performed to adjust the size.

Next, electrode current collector 110 is formed by forming protrusion 111 on electrode current collector 10 (step S16). The formation of protrusion 111 is performed by, for example, a removal process in which part of first region 71 is removed. The removal process employs cutting tools such as cutters, slitters, cutting machines, and die-cutting machines incorporating Thomson blades, as well as means such as lasers or jets, but the present disclosure is not limited to these methods. In addition, foil or the like having the shape of separately prepared protrusion 111 may be bonded to electrode current collector 10. Means such as ultrasonic welding, resistance welding, and crimping are used for this bonding, but the present disclosure is not limited to these methods. It should be noted that protrusion 111 may be formed at any stage of manufacturing battery 501. In addition, in step S11, electrode current collector 110 with protrusion 111 formed in advance may be prepared.

Next, counter electrode current collector 150 is stacked on the side of third layer 40 opposite from second layer 30 (step S17). This provides a stacked body (unit cell 560) in which first layer 20, second layer 30, third layer 40, and counter electrode current collector 150 are stacked in this order on both main surfaces 11 and 12 of electrode current collector 110. At this time, counter electrode current collector 150 is stacked on third layer 40 so that fourth region 74 not covered with counter electrode current collector 150 is provided at the end portion of third layer 40 in the x-axis positive side direction. In addition, at this time, third layer 40 and counter electrode current collector 150 are bonded by, for example, a high-pressure pressing treatment. In addition, the bonding may be performed by using counter electrode current collector 150 having a connecting layer containing an adhesive binder, coating an adhesive agent, or stacking an adhesive film. The method of bonding is not limited to these methods. In addition, a heat treatment may be performed during or after the bonding.

Counter electrode current collector 150 formed in advance to achieve the desired size before stacking may be used, or counter electrode current collector 150 may be partially removed after stacking. In addition, protrusion 151 may be formed after the stacking.

Next, unit cell 560 obtained in step S17 is cut along the direction intersecting main surface 11, and a cut surface is formed as side surfaces 62, 63 and 64 at the end portions of unit cell 560 in the x-axis negative side direction, y-axis positive side direction, and y-axis negative side direction (step S18). This cutting creates three sides of unit cell 560 that constitute the end portions in the x-axis negative side direction, the y-axis positive side direction, and the y-axis negative side direction, which are different from the end portions where first region 71, second region 72, third region 73, and fourth region 74 are provided, in a plan view. Cutting is performed by using cutting tools such as a cutter, an ultrasonic cutter, a slitter, a dicer, a cutting machine, cutting machines, and die-cutting machines incorporating Thomson blades, as well as means such as lasers or jets, but the present disclosure is not limited to these methods. In addition, in order to prevent short circuits, side surfaces 62, 63, and 64 may be polished after cutting to remove burrs and the like.

In step S18, electrode current collector 110, first layer 20, second layer 30, third layer 40, and counter electrode current collector 150 are cut collectively in the direction intersecting main surface 11. The direction intersecting main surface 11 is specifically a direction perpendicular to main surface 11, and can be said to be a stacking direction of unit cells 560. This makes it possible to easily manufacture battery 501 because it is not necessary to stack electrode current collector 110, first layer 20, second layer 30, third layer 40 and counter electrode current collector 150 in the shape after cutting. In addition, the regions in which first region 71, second region 72, third region 73 and fourth region 74 are provided remain uncut, and an electrical connection structure such as terminals can be formed in a structure that can suppress the occurrence of short circuits. In addition, since the capacity of battery 501 can be adjusted at the position where unit cell 560 is to be cut, the capacity accuracy can be improved.

On the cut surface, the side surfaces of electrode current collector 110, first layer 20, second layer 30, third layer 40, and counter electrode current collector 150 are exposed. It should be noted that after cutting, in order to protect these exposed side surfaces, a sealing member or the like may be disposed to cover these side surfaces. That is, when these side surfaces are covered with other members such as sealing members, these exposed side surfaces may be covered with other members.

Through the steps described above, battery 501 composed of one unit cell 560 is obtained. By the above manufacturing method, battery 501 having high resistance to short circuits can be manufactured with high efficiency. Obtained battery 501 may be housed in an exterior body or the like. When battery 501 is housed in the exterior body, protrusions 111 and 151 are drawn out to the exterior body. In addition, in obtained battery 501, a process may be performed to remove the corners (intersections of the side surfaces) in a plan view by cutting or the like. At this time, when the corner in the x-axis positive side direction is to be removed, for example, the portion including first region 71, second region 72, third region 73, and fourth region 74 is removed. This removes corners that are prone to collapse and breakage, and can further improve reliability of battery 501.

It should be noted that the order of steps S17 and S18 may be changed. In this case, first, after step S16, in step S18, the stacked body (stacked electrode plate) in which electrode current collector 110, first layer 20, second layer 30, and third layer 40 are stacked is cut in the direction intersecting main surface 11, and a cut surface is formed at the end portions of the stacked electrode plate in the x-axis negative side direction, the y-axis positive side direction, and the y-axis negative side direction. At this time, electrode current collector 110, first layer 20, second layer 30, and third layer 40 are cut collectively in the direction intersecting main surface 11. This makes it possible to easily manufacture battery 501 because there is no need to stack electrode current collector 110, first layer 20, second layer 30, and third layer 40 in the shape after cutting. Thereafter, in step S17, counter electrode current collector 150 having a shape according to the shape of the stacked electrode plate after the cut surface is formed is stacked on the side of third layer 40 opposite from second layer 30. This provides battery 501 composed of one unit cell 560.

### Embodiment 2

Next, Embodiment 2 will be described. In Embodiment 2, a stacked battery in which a plurality of unit cells are stacked will be described. It should be noted that in the following description, differences from Embodiment 1 and respective Variations mentioned above will be mainly described, and descriptions of commonalities will be omitted or simplified as appropriate.

### [1. Configuration]

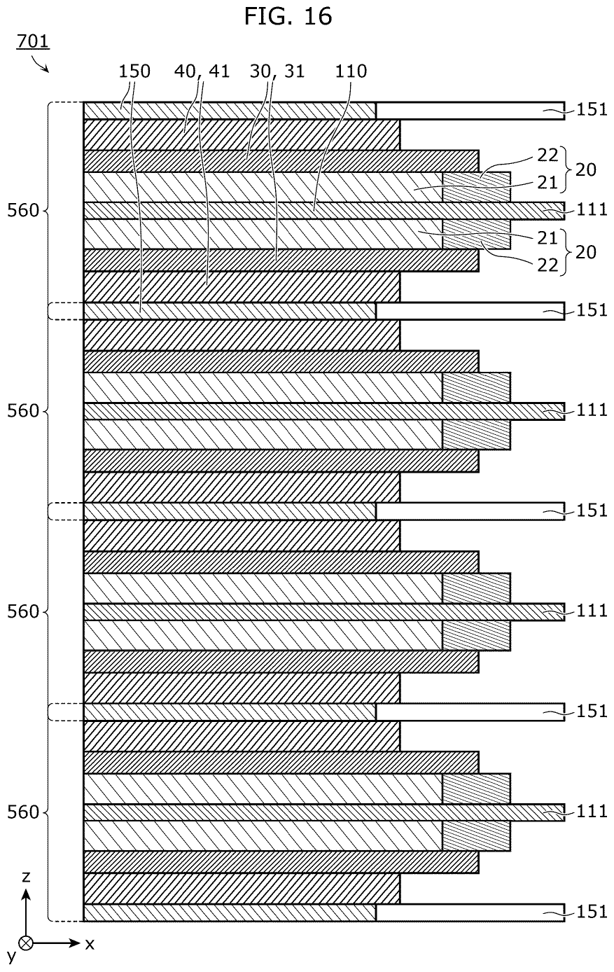

First, the configuration of the battery according to Embodiment 2 will be described with reference to the drawings. FIG. 16 is a cross-sectional view of battery 701 according to the present embodiment. As illustrated in FIG. 16, battery 701 includes a plurality of unit cells 560 according to Variation 5 of Embodiment 1, and has a structure in which a plurality of unit cells 560 are stacked. Since unit cells 560 described above are stacked in battery 701, battery 701 that achieves both high resistance to short circuits and high production efficiency can be realized.

The plurality of unit cells 560 have the same structure and are stacked so as to be electrically connected in parallel. First layers 20, second layer 30, and third layers 40 stacked on main surfaces on both sides of each current collector are in the same order as each other in the stacking order from the current collector. In addition, the plurality of unit cells 560 are stacked so that the positions of the side surfaces of unit cells 560 coincide when viewed from the stacking direction. For that reason, the side surface of each of unit cells 560 in the x-axis negative side direction, y-axis positive side direction, and y-axis negative side direction are flush. In addition, in the plurality of unit cells 560, protrusion 151 and protrusion 111 protrude in the same direction, specifically in the x-axis positive side direction. Protrusions 151 of the plurality of unit cells 560 and protrusions 111 of the plurality of unit cells 560 may be bundled and bonded together by welding or the like.

In the example illustrated in FIG. 16, the number of unit cells 560 to be stacked is four, but may be two or three, or five or more.

In the example illustrated in FIG. 16, two adjacent unit cells 560 share counter electrode current collector 150. It should be noted that two adjacent unit cells 560 may have such an arrangement that two adjacent unit cells 560 do not share counter electrode current collector 150, but the two adjacent unit cells 560 each have individual counter electrode current collectors 150, and two counter electrode current collectors 150 overlap between third layers 40. At this time, a conductive adhesive layer may be provided between the two counter electrode current collectors 150.

It should be noted that in the stacked battery according to the present embodiment, instead of unit cell 560, the unit cells described above according to Embodiment 1 and each Variation other than unit cell 560 may be used as the unit cell to be stacked. Even if unit cells other than unit cells 560 are stacked, adjacent unit cells may share a current collector, or the unit cells may be stacked with two separate current collectors overlapping each other without sharing current collectors. In addition, when unit cells such as unit cells 60, in which first layer 20 and the like are stacked on only one main surface 11 of electrode current collector 10 or 110, are stacked, the unit cells may be stacked so as to be electrically connected in series. In addition, the plurality of unit cells may include unit cells having different configurations. In addition, the plurality of unit cells may include unit cells having a different configuration from the unit cells according to Embodiment 1 and respective Variations.

### [2. Manufacturing Method]

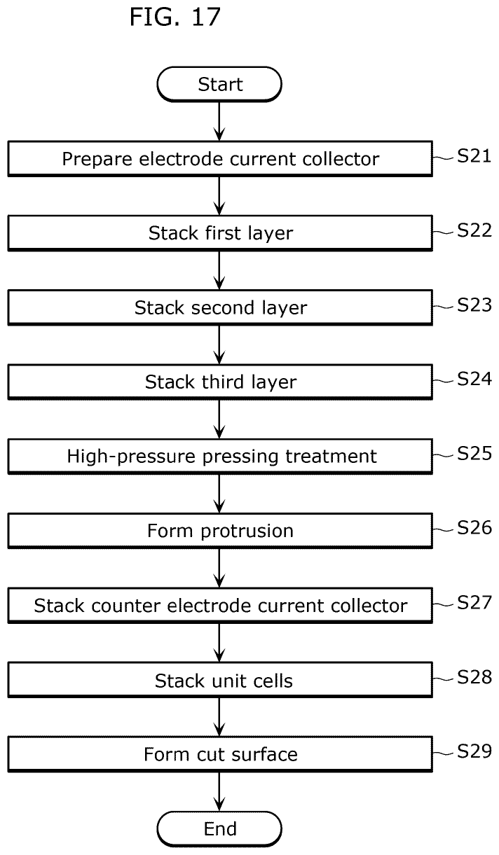

Next, a manufacturing method of the battery according to the present embodiment will be described. The following description will focus on a manufacturing method of battery 701 in which a plurality of unit cells 560 are stacked, but batteries in which the unit cells according to Embodiment 1 and respective Variations described above other than unit cell 560 are stacked can also be manufactured by appropriately applying the following manufacturing method. FIG. 17 is a flow chart illustrating a manufacturing method of battery 701 according to Embodiment 2. It should be noted that the manufacturing method of battery 701 described below is an example, and the manufacturing method of battery 701 is not limited to the following example.

First, in steps S21 to S26 illustrated in FIG. 17, the same number of stacked electrode plates as the number of unit cells 560 included in battery 701 is formed by the same method as the steps S11 to S16 described with reference to FIG. 14. The stacked electrode plate may be large stacked electrode plate 90 as illustrated in FIG. 15, or may be a stacked electrode plate formed so as to correspond to the size of unit cell 560. It should be noted that steps S21 to S26 may be omitted, and the same number of the stacked electrode plates as the number of unit cells 560 provided in the pre-formed battery 701 may be prepared.

Next, counter electrode current collector 150 is stacked on the side of third layer 40 opposite from second layer 30 and a plurality of unit cells 560 are stacked (steps S27 and S28). For example, counter electrode current collector 150 and the stacked electrode plate obtained up to step S26 are alternately stacked, so that counter electrode current collector 150 is shared by adjacent unit cells 560, and counter electrode current collector 150 is stacked on third layer 40 and the plurality of unit cells 560 are stacked. Alternatively, a unit cell may be formed by stacking counter electrode current collector 150 only on one of two third layers 40 of the stacked electrode plate, thereby removing one counter electrode current collector 150 from unit cell 560, and such unit cells may be stacked. By stacking the unit cells with counter electrode current collector 450 sandwiched between third layers 40, counter electrode current collector 150 is also shared by adjacent unit cells 560. In this case, after stacking as many unit cells as necessary, counter electrode current collector 150 is stacked onto third layer 40, which lacks counter electrode current collector 150 because it is the end layer in the stacking direction.

When stacking these layers, third layer 40 and counter electrode current collector 150 may be bonded by a high-pressure pressing treatment or the like, similar to step S17. This bonding may be performed at a stage during the stacking of counter electrode current collectors 150 and the stacked electrode plates, or may be performed collectively after all of counter electrode current collectors 450 and the stacked electrode plates have been stacked. When the bonding is performed collectively, for example, all of the plurality of counter electrode current collectors 150 and the plurality of stacked electrode plates are stacked, and after stacking, they are pressed collectively.

In addition, similar to step S17, for counter electrode current collector 150, one that has been pre-formed to the desired dimensions prior to stacking may be used, or a portion thereof may be removed after stacking. In addition, protrusion 151 may be formed after the stacking.

It should be noted that when battery 701 is manufactured in which two adjacent unit cells 560 do not share counter electrode current collector 150, and two counter electrode current collector 150 are overlapped and disposed between third layers 40, the same process as in step S17 is performed in step S27 to obtain a stacked body (unit cell 560) in which first layer 20, second layer 30, third layer 40, and counter electrode current collector 150 are stacked in this order on both main surfaces 11 and 12 of electrode current collector 110. Then, in step S28, obtained unit cells 560 are stacked. At this time, the bonding of unit cells 560 is performed by a conductive adhesive layer formed by coating an adhesive or by stacking an adhesive film. However, the bonding method is not limited to these methods. In addition, heat treatment and pressing may be performed after bonding. For example, by stacking unit cells 560, all of the plurality of counter electrode current collectors 150 and the plurality of stacked electrode plates may be stacked, and after stacking, they may be pressed collectively.

Next, the stacked body of the plurality of unit cells 560 obtained in step S28 is cut along the direction intersecting main surface 11, and a cut surface is formed as side surfaces 62, 63 and 64 at the respective end portions of the plurality of unit cells 560 in the x-axis negative side direction, y-axis positive side direction, and y-axis negative side direction (step S29). This cutting creates three sides of the plurality of unit cells 560 that constitute the end portions, which are different from the end portions where first region 71, second region 72, third region 73, and fourth region 74 are provided, in a plan view. The cutting method can be performed in the same manner as in step S18 described above. In step S29, all of the plurality of unit cells 560 are cut collectively in the direction intersecting main surface 11. This makes it possible to easily manufacture battery 701 because it is not necessary to stack electrode current collector 110, first layer 20, second layer 30, third layer 40 and counter electrode current collector 150 of each of the plurality of unit cells 560 in the shape after cutting. In addition, the regions in which first region 71, second region 72, third region 73 and fourth region 74 are provided remain uncut, and an electrical connection structure such as terminals can be formed in a structure that can suppress the occurrence of short circuits.

On the cut surface, the side surfaces of electrode current collector 110, first layer 20, second layer 30, third layer 40, and counter electrode current collector 150 of each of the plurality of unit cells 560 are exposed. It should be noted that after cutting, in order to protect these exposed side surfaces, a sealing member or the like may be disposed to cover these side surfaces. That is, when these side surfaces are covered with other members such as sealing members, these exposed side surfaces may be covered with other members.

Through the steps as described above, battery 701 having a structure in which a plurality of unit cells 560 are stacked is obtained. Obtained battery 701 may be housed in an exterior body or the like. When battery 701 is housed in the exterior body, protrusions 111 and 151 are drawn out to the exterior body. In addition, in obtained battery 701, a process may be performed to remove the corners (intersections of the side surfaces) in a plan view by cutting or the like.

It should be noted that the formation of the cut surface in step S29 may be performed before step S28. In this case, in step S28, the unit cells on which the cut surfaces are formed are stacked to obtain battery 701.

In addition, the stacked electrode plate and counter electrode current collector 150 stacked in steps S27 and S28 are not limited to a configuration that corresponds to a plurality of unit cells 560, and may be the stacked electrode plate and counter electrode current collector having a configuration that corresponds to the battery to be manufactured. For example, the stacked electrode plate and counter electrode current collector used in steps S27 and S28 may have a configuration corresponding to the unit cells according to Embodiment 1 and respective Variations described above other than unit cells 560.

### Other Embodiments

The batteries and battery manufacturing method according to the present disclosure have been described above based on the embodiments, but the present disclosure is not limited to these embodiments. Forms obtained by applying various modifications to the embodiments conceived by a person skilled in the art or forms realized by combining some components in the embodiments without departing from the spirit of the present disclosure are also included within the scope of this disclosure.

In the embodiments described above, the battery includes an electrode current collector, a first layer, a second layer, a third layer, and a counter electrode current collector, or an electrode current collector, a first layer, a second layer, a third layer, a counter electrode current collector and an insulating member, but the present disclosure is not limited thereto. For example, bonding layers and the like for the purpose of the reduction in electrical resistance, the improvement of bonding strength, and the like may be provided between the layers of the battery within the range where the battery characteristics are acceptable.

In addition, in the embodiments describe above, the unit cell is formed by sequentially stacking the first layer, second layer, and third layer directly from the main surface side of the electrode current collector, but the present disclosure is not limited thereto. For example, the unit cell may be formed by sequentially stacking a first layer, a second layer, and a third layer onto a sheet-like substrate, and the first layer, second layer, and third layer that have been formed may be removed from the substrate and stacked onto the main surface of the electrode current collector. In addition, a first layer, a second layer and a third layer may be formed on a sheet-like substrate, and stacking may be performed by sequentially transferring the first layer, the second layer, and the third layer that have been formed onto the main surface of the electrode current collector.

In addition, the first insulating layer and the second insulating layer, or the second insulating layer and the third insulating layer may be one insulating layer together. That is, there may be no boundary between the first insulating layer and the second insulating layer, or between the second insulating layer and the third insulating layer.

In addition, the first insulating layer, second insulating layer, and third insulating layer may be one insulating layer together. That is, there may be no boundary between the first insulating layer, the second insulating layer, and the third insulating layer.

In addition, various changes, replacements, additions, omissions, and the like can be made to the respective embodiments described above within the scope of the claims or the equivalents thereof.

### INDUSTRIAL APPLICABILITY

The battery according to the present disclosure can be used, for example, as a secondary battery such as an all-solid-state battery used in various electronic devices, automobiles, or the like.

1. A battery comprising:
a unit cell including:
an electrode current collector;
a first layer disposed on a main surface of the electrode current collector;
a second layer disposed on a side of the first layer opposite from the electrode current collector;
a third layer disposed on a side of the second layer opposite from the first layer; and
a counter electrode current collector disposed on a side of the third layer opposite from the second layer,
wherein the first layer includes an electrode active material layer and a first insulating layer having an electronic insulation property, the first insulating layer being aligned with the electrode active material layer in a first direction that is a direction from a center of the main surface towards an outer edge of the main surface of the electrode current collector, the first insulating layer being disposed at an end portion of the first layer in the first direction,
the second layer includes an electrolyte layer,
the third layer includes a counter electrode active material layer,
a first region not covered with the first layer is provided at an end portion of the main surface of the electrode current collector in the first direction,
a second region not covered with the second layer in a plan view of the main surface of the electrode current collector is provided at the end portion of the first layer in the first direction, and
a third region not covered with the third layer in the plan view is provided at an end portion of the second layer in the first direction.

2. The battery according to claim 1,
wherein the unit cell includes two first layers, two second layers, two third layers, and two counter electrode current collectors, the two first layers each being the first layer, the two second layers each being the second layer, the two third layers each being the third layer, the two counter electrode current collectors each being the counter electrode current collector,
the two first layers are disposed on two main surfaces of the electrode current collector, the two main surfaces including the main surface,
the two second layers are disposed on sides of the two first layers opposite from the electrode current collector,
the two third layers are disposed on sides of the two second layers opposite from the two first layers,
the two counter electrode current collectors are disposed on sides of the two third layers opposite from the two second layers,
the first region is provided at an end portion of each of the two main surfaces of the electrode current collector in the first direction,
the second region is provided at an end portion of each of the two first layers in the first direction, and
the third region is provided at an end portion of each of the two second layers in the first direction.

3. The battery according to claim 1,
wherein a fourth region not covered with the counter electrode current collector in the plan view is provided at an end portion of the third layer in the first direction.

4. The battery according to claim 3,
wherein the unit cell includes two first layers, two second layers, two third layers, and two counter electrode current collectors, the two first layers each being the first layer, the two second layers each being the second layer, the two third layers each being the third layer, the two counter electrode current collectors each being the counter electrode current collector,
the two first layers are disposed on two main surfaces of the electrode current collector, the two main surfaces including the main surface,
the two second layers are disposed on sides of the two first layers opposite from the electrode current collector,
the two third layers are disposed on sides of the two second layers opposite from the two first layers,
the two counter electrode current collectors are disposed on sides of the two third layers opposite from the two second layers,
the first region is provided at an end portion of each of the two main surfaces of the electrode current collector in the first direction,
the second region is provided at an end portion of each of the two first layers in the first direction,
the third region is provided at an end portion of each of the two second layers in the first direction, and
the fourth region is provided at an end portion of each of the two third layers in the first direction.

5. The battery according to claim 1,
wherein the second layer further includes a second insulating layer having an electronic insulation property, the second insulating layer being aligned with the electrolyte layer in the first direction and disposed at an end portion of the second layer in the first direction.

6. The battery according to claim 1,
wherein the third region is part of the electrolyte layer.

7. The battery according to claim 3,
wherein the third layer further includes a third insulating layer having an electronic insulation property, the third insulating layer being aligned with the counter electrode active material layer in the first direction, the third insulating layer being disposed at an end portion of the third layer in the first direction.

8. The battery according to claim 1,
wherein side surfaces of the electrode current collector, the first layer, the second layer, and the third layer are flush with each other at an end portion of the unit cell in a second direction that is a direction from the center towards the outer edge of the main surface of the electrode current collector, the second direction being different from the first direction.

9. The battery according to claim 1,
wherein side surfaces of the electrode current collector, the first layer, the second layer, the third layer, and the counter electrode current collector are flush with each other at an end portion of the unit cell in a second direction that is a direction from the center towards the outer edge of the main surface of the electrode current collector, the second direction being different from the first direction.

10. The battery according to claim 1,
wherein at least one layer selected from a group consisting of the electrode active material layer, the first insulating layer, and the electrolyte layer includes a sulfide solid electrolyte.

11. The battery according to claim 1,
wherein at least one layer selected from a group consisting of the electrode active material layer, the first insulating layer, and the electrolyte layer includes a styrene-based elastomer.

12. The battery according to claim 1,
wherein part of the end portion of the counter electrode current collector in the first direction protrudes in the first direction relative to the third layer in the plan view.

13. The battery according to claim 1, comprising:
a plurality of unit cells, each of the plurality of unit cells being the unit cell,
wherein the plurality of unit cells are stacked.

14. A battery manufacturing method comprising:
preparing an electrode current collector and stacking a first layer on a main surface of the electrode current collector to provide a first region not covered with the first layer at an end portion of the main surface of the electrode current collector in a first direction that is a direction from a center of the main surface towards an outer edge of the main surface of the electrode current collector;
stacking a second layer on a side of the first layer opposite from the electrode current collector to provide a second region not covered with the second layer in a plan view of the main surface of the electrode current collector at an end portion of the first layer in the first direction;
stacking a third layer on a side of the second layer opposite from the first layer to provide a third region not covered with the third layer in the plan view at an end portion of the second layer in the first direction; and
stacking a counter electrode current collector on a side of the third layer opposite from the second layer,
wherein the first layer includes an electrode active material layer and a first insulating layer having an electronic insulation property, the first insulating layer being aligned with the electrode active material layer in the first direction, the first insulating layer being disposed at an end portion of the first layer in the first direction,
the second layer includes an electrolyte layer, and
the third layer includes a counter electrode active material layer.

15. The battery manufacturing method according to claim 14,
wherein in the stacking of the counter electrode current collector, the counter electrode current collector is stacked on the third layer to provide a fourth region not covered with the counter electrode current collector in the plan view at an end portion of the third layer in the first direction.

16. The battery manufacturing method according to claim 14, further comprising:
forming a cut surface at an end portion of a stacked body in a second direction by collectively cutting the electrode current collector, the first layer, the second layer, and the third layer in a direction intersecting the main surface of the electrode current collector, the second direction being different from the first direction and being a direction from the center towards the outer edge of the main surface of the electrode current collector, the electrode current collector, the first layer, the second layer, and the third layer being stacked in the stacked body.

17. The battery manufacturing method according to claim 14, further comprising:
forming a cut surface at an end portion of a stacked body in a second direction by collectively cutting the electrode current collector, the first layer, the second layer, the third layer, and the counter electrode current collector in a direction intersecting the main surface of the electrode current collector, the second direction being different from the first direction and being a direction from the center towards the outer edge of the main surface of the electrode current collector, the electrode current collector, the first layer, the second layer, the third layer, and the counter electrode current collector being stacked in the stacked body.
